(19) United States
(12) Patent Application Publication
(10) Pub. No.: US 2026/0237373 A1
(43) Pub. Date: Aug. 13, 2026

(54) Multi-Rate Processing for Active Noise Cancellation

(71) Applicant: Google LLC, Mountain View, CA (US)

(72) Inventors: Jens Kristian Poulsen, Kitchener (CA); Trausti Thormundsson, Irvine, CA (US); Michael Granville Chorn, Longmont, CO (US); Xiaojun Chen, Longmont, CO (US)

(73) Assignee: Google LLC, Mountain View, CA (US)

(21) Appl. No.: 19/156,572

(22) PCT Filed: Aug. 1, 2024
(86) PCT No.: PCT/US2024/040613

§ 371 Date: Aug. 14, 2025

Related U.S. Application Data
(60) Provisional application No. 63/517,500, filed on Aug. 3, 2023.

(51) Int. Cl. G10K 11/178

(52) U.S. Cl. CPC G10K 11/17853; G10K 11/17873

(57) ABSTRACT

Techniques and apparatuses are described that implement multi-rate processing for active noise cancellation. Instead of performing active noise cancellation using a single processing rate, multi-rate processing utilizes multiple processing paths associated with multiple processing rates. With the multiple processing rates, active-noise-cancellation circuitry can avoid the tradeoff between responsiveness (e.g., latency) and power efficiency (e.g., power consumption) that is associated with a single processing rate and instead be tailored for both responsiveness and power efficiency. To overcome the tradeoff, at least one of the processing paths has a processing rate that facilitates responsiveness and at least one other processing path has a processing rate that facilitates power efficiency. In this way, the described techniques for multi-rate processing enables the active-noise-cancellation circuitry to realize both a target level of responsiveness and a target power efficiency.

### BACKGROUND

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content. To improve aesthetics and reduce encumbrance, it is desirable to design wireless hearables with smaller sizes. It is also desirable to design the wireless hearables in a manner that efficiently utilizes available power in order to provide longer operational times.

### SUMMARY

Techniques and apparatuses are described that implement multi-rate processing for active noise cancellation. Instead of performing active noise cancellation using a single processing rate, multi-rate processing utilizes multiple processing paths associated with multiple processing rates. With the multiple processing rates, active-noise-cancellation circuitry can avoid the tradeoff between responsiveness (e.g., latency) and power efficiency (e.g., power consumption) that is associated with single-processing-rate designs and instead be optimized for both responsiveness and power efficiency. To overcome this tradeoff, at least one of the processing paths has a processing rate that is optimized for responsiveness and at least one other processing path has a processing rate that is optimized for power efficiency. In this way, the described techniques for multi-rate processing enables the active-noise-cancellation circuit to realize both a target level of responsiveness and a target power efficiency.

Aspects described below include a method for performing multi-rate processing for active noise cancellation. The method includes generating, using active-noise-cancellation circuitry, multiple anti-noise signal components by processing an input noise reference signal using multiple processing paths of the active-noise-cancellation circuitry. The multiple processing paths are associated with different processing rates. The method also includes generating, using the active-noise-cancellation circuitry, an anti-noise signal for active noise cancellation by combining the multiple anti-noise signal components from the multiple processing paths.

Aspects described below include an apparatus comprising active-noise-cancellation circuitry configured to perform any one of the described methods.

Aspects described below include a computer-readable storage medium comprising computer-executable instructions that, responsive to execution by a processor, cause active-noise-cancellation circuitry to perform any one of the described methods.

Aspects described below also include a system with means for performing multi-rate processing for active noise cancellation.

### BRIEF DESCRIPTION OF DRAWINGS

Apparatuses for and techniques that implement multi-rate processing for active noise cancellation are described with reference to the following drawings. The same numbers are used throughout the drawings to reference like features and components:

FIG. 1 illustrates an example environment in which a hearable capable of performing multi-rate processing for active noise cancellation can be implemented;

FIG. 2 illustrates an example implementation of a computing device;

FIG. 3 illustrates an example implementation of a hearable;

FIG. 4 illustrates example impulse responses associated with active noise cancellation;

FIG. 5 illustrates example components of a hearable capable of performing active noise cancellation;

FIG. 6 illustrates an example implementation of active-noise-cancellation circuitry having multiple processing paths associated with multiple processing rates;

FIG. 7 illustrates example components of a processing path;

FIG. 8 illustrates an example implementation of a processing path;

FIG. 9 illustrates an example implementation of a processing circuit having two processing paths;

FIG. 10 illustrates an example implementation of a processing circuit having more than two processing paths;

FIG. 11 illustrates an example flow diagram for performing a calibration process to configure active-noise-cancellation circuitry for multi-rate processing;

FIG. 12 illustrates an example processing circuit that performs multi-domain processing;

FIG. 13 illustrates example components of a bit-based finite-impulse-response filter;

FIG. 14 illustrates an example implementation of a finite-impulse-response filter;

FIG. 15 illustrates a first example implementation of a bit-based finite-impulse-response filter with a multiplexing circuit;

FIG. 16 illustrates a second example implementation of a bit-based finite-impulse-response filter with a reduced-tap delay line;

FIG. 17 illustrates an example implementation of a processing path associated with a pulse-density-modulation domain;

FIG. 18 illustrates example implementations of a single-tap delay line and a multi-tap delay line;

FIG. 19 illustrates an example implementation of a processing circuit including multiple alignment circuits;

FIG. 20 illustrates an example implementation of a processing circuit including an ultrasound detector;

FIG. 21 illustrates an example method for performing aspects of multi-rate processing for active noise cancellation;

FIG. 22 illustrates an example method for performing aspects of multi-domain processing for active noise cancellation; and

FIG. 23 illustrates an example computing system embodying, or in which techniques may be implemented that enable use of, a hearable capable of performing multi-rate processing for active noise cancellation.

### DETAILED DESCRIPTION

Wireless technology has become prevalent in everyday life, making communication and data readily accessible to users. One type of wireless technology are wireless hearables, examples of which include wireless earbuds and wireless headphones. Wireless hearables have allowed users freedom of movement while listening to audio content from music, audio books, podcasts, and videos. To improve aesthetics and reduce encumbrance, it is desirable to design wireless hearables with smaller sizes. It is also desirable to design the wireless hearables in a manner that efficiently utilizes available power in order to provide longer operational times.

To improve the user experience, some wireless hearables can provide additional features such as active noise cancellation. With active noise cancellation, a wireless hearable can attenuate noise that is present in an external environment and make it easier for the user to hear the audio content. Active noise cancellation, however, can also increase power consumption of the wireless hearable. For many active-noise-cancellation designs there is an inverse relationship between power consumption and active-noise-cancellation performance. Generally speaking, power consumption is proportional to the square of a processing rate associated with active noise cancellation (e.g., the square of an operating frequency of a filter used for active noise cancellation).

To improve accuracy and reduce latency, active noise cancellation can be performed at a faster processing rate (e.g., using a filter operating at a higher frequency) at the cost of consuming additional power. To support the faster processing rate, circuitry that performs the active noise cancellation may have a bigger footprint (e.g., increased die area), which can also increase cost. Alternatively, active noise cancellation can be performed at a slower processing rate (e.g., using a filter operating at a lower frequency) to conserve power at the cost of increasing latency, which can reduce accuracy. Consequently, active noise cancellation performed at the slower processing rate may have poorer performance compared to active noise cancellation performed at the faster processing rate. It can be challenging to implement active noise cancellation in a manner that balances performance with power consumption.

To address this challenge, techniques for implementing multi-rate processing for active noise cancellation are described herein. Instead of performing active noise cancellation using a single processing rate, multi-rate processing utilizes multiple processing paths associated with multiple processing rates. With the multiple processing rates, active-noise-cancellation circuitry can avoid the tradeoff between responsiveness (e.g., latency) and power efficiency (e.g., power consumption) that is associated with single-processing-rate designs and instead be tailored for both responsiveness and power efficiency. To overcome this tradeoff, at least one of the processing paths has a processing rate that facilitates responsiveness and at least another one of the processing paths has a processing rate that facilitates power efficiency. In this way, the processing path with the responsive processing rate compensates for latency associated with the other processing path that has the power-efficient processing rate. Likewise, the processing path with the power-efficient processing rate utilizes significantly less power than the processing path with the responsive processing rate to improve the overall power efficiency of the active-noise-cancellation circuitry. The different processing rates represent different sampling rates of a noise reference signal. The processing paths process (e.g., filter) different versions of the noise reference signals corresponding to the different sampling rates. The described techniques for multi-rate processing enables the active-noise-cancellation circuit to realize both a target level of responsiveness and a target power efficiency. The techniques of multi-rate processing can also be combined with other techniques, such as multi-domain processing and/or bit-based finite-impulse-response filtering.

Techniques for implementing multi-domain processing are also described herein. Instead of performing active noise cancellation based on a single domain type, multi-domain processing utilizes multiple processing paths associated with different domain types. In particular, active-noise-cancellation circuitry includes at least one first processing path associated with a pulse-density-modulation domain and at least one second processing path associated with a pulse-code-modulation domain. In an example implementation, the first processing path is associated with a responsive processing rate while the second processing path is associated with a power-efficient processing rate. The pulse-density-modulation domain enables a tunable filter within the at least one first processing path to be designed in a manner that reduces power consumption. The pulse-code-modulation domain along with the power-efficient processing rate provides additional freedom and flexibility in designing the tunable filter within the at least one second processing path. In some cases, the tunable filter associated with the pulse-code-modulation domain can be designed to perform other, sometimes more complicated, operations, such as multi-band compression, envelope detection, and/or non-linear filtering. Furthermore, power-consumption constraints and/or latency constraints can be relaxed, which enables the tunable filter to be designed for performance.

Techniques for implementing bit-based finite-impulse-response filtering are also described herein. In particular, active-noise-cancellation circuitry includes at least one processing path associated with a pulse-density-modulation domain. To reduce power consumption, the tunable filter within this processing path is implemented as a bit-based finite-impulse-response filter. An architecture of the bit-based finite-impulse-response filter takes advantage of characteristics associated with pulse-density-modulation domain to simplify and/or reduce a quantity of computations in order to improve power efficiency. Various techniques of bit-based finite-impulse-response filtering can modify a delay line, a multiplication circuit, and/or an integration circuit of a finite-impulse-response filter to improve the power efficiency.

Some implementations of active-noise-cancellation circuitry combine the techniques for multi-rate processing, multi-domain processing, and bit-based finite-impulse-response filtering. This enables the power-efficient processing rates to be reduced further, which further improves power efficiency. The techniques for multi-rate processing, multi-domain processing, and bit-based finite-impulse-response filtering are not limited to active noise cancellation. These techniques can be used in other signal-processing applications, such as wireless communication. Generally speaking, these techniques can be applied to other use cases that involve processing signals at low power.

### Operating Environment

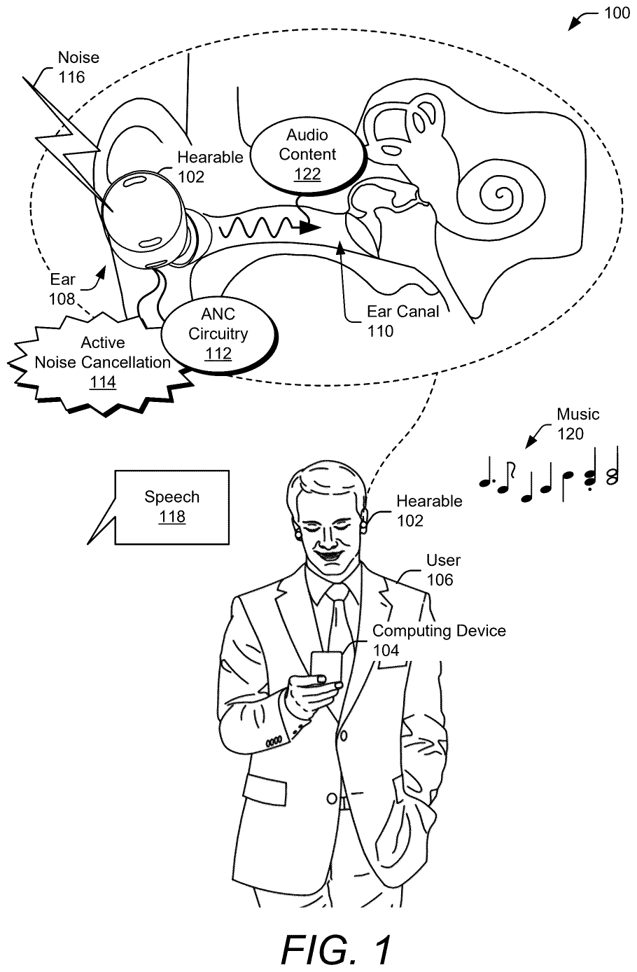

FIG. 1 is an illustration of an example environment 100 in which multi-rate processing for active noise cancellation can be implemented. In the example environment 100, a hearable 102 is connected to a computing device 104 using a wireless interface. In other implementations, the hearable 102 can connect to the computing device 104 using a wired interface. The hearable 102 is a device that can render audible content and direct the audible content into a user 106's ear 108. In some cases, the hearable 102 can provide stereo-quality sound.

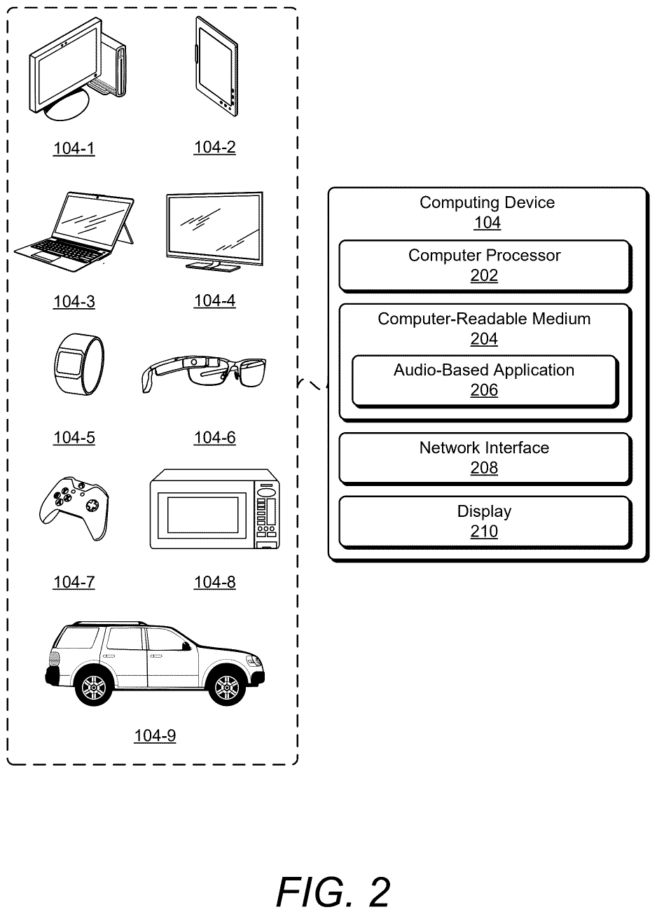

In this example, the hearable 102 operates together with the computing device 104. More specifically, the computing device 104 provides audio content to the hearable 102. The hearable 102 can optionally provide other audio content to the computing device 104. In other examples, the hearable 102 can operate or be implemented as a stand-alone device. Although depicted as a smartphone, the computing device 104 can include other types of devices, including those described with respect to FIG. 2.

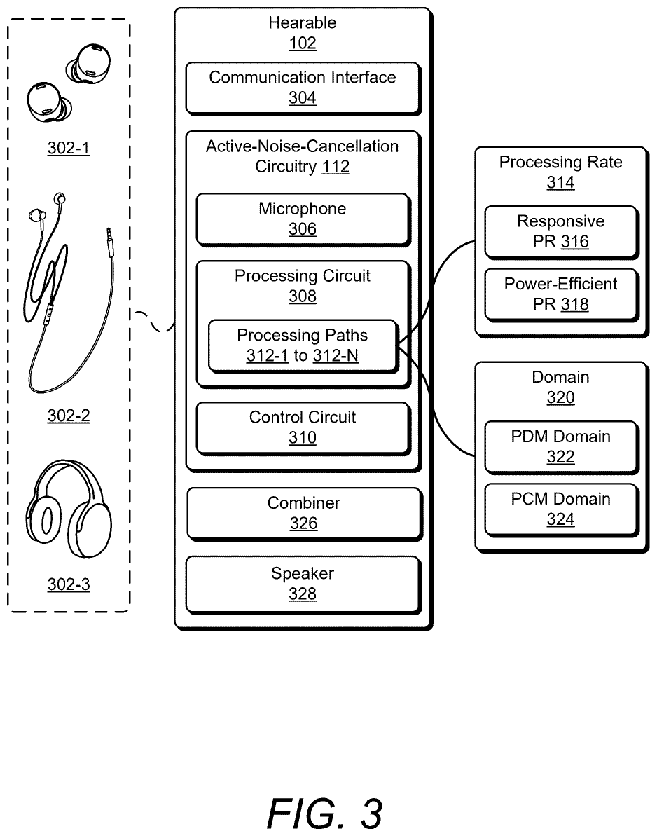

The hearable 102 is illustrated as an earbud (e.g., an earpiece, in-ear headphones, or canalphones) in FIG. 1. The user 106 can insert the earbud at least partially into their ear canal 110. Although described with respect to earbuds, the techniques of multi-rate processing, multi-domain processing, and/or bit-based finite-impulse-response filtering for active noise cancellation can also be applied to other types of hearables 102, as further described with respect to FIG. 3.

The hearable 102 includes active-noise-cancellation circuitry 112 (ANC circuitry 112), which can perform aspects of active noise cancellation 114. With active noise cancellation 114, the hearable 102 can significantly attenuate external noise 116, such as speech 118, music 120, or other background sounds (e.g., traffic, operating sounds of a machine or vehicle, or sounds made by nature). In this manner, active noise cancellation 114 can create a quiet environment for the user 106 to concentrate or sleep. Additionally or alternatively, active noise cancellation 114 can make it easier for the user 106 to hear audio content 122 that is rendered for the user 106. The audio content 122 can represent any type of sound that is produced by the hearable 102, such as music, a ringtone, an alarm, a caller's voice, and so forth. The computing device 104 is further described with respect to FIG. 2.

FIG. 2 illustrates an example computing device 104. The computing device 104 is illustrated with various non-limiting example devices including a desktop computer 104-1, a tablet 104-2, a laptop 104-3, a television 104-4, a computing watch 104-5, computing glasses 104-6, a gaming system 104-7, a microwave 104-8, and a vehicle 104-9. Other devices may also be used, such as a home service device, a smart speaker, a smart thermostat, a baby monitor, a Wi-Fi™ router, a drone, a trackpad, a drawing pad, a netbook, an e-reader, a home automation and control system, a wall display, and another home appliance. Note that the computing device 104 can be wearable, non-wearable but mobile, or relatively immobile (e.g., desktops and appliances).

The computing device 104 includes one or more computer processors 202 and at least one computer-readable medium 204, which includes memory media and storage media. Applications and/or an operating system (not shown) embodied as computer-readable instructions on the computer-readable medium 204 can be executed by the computer processor 202 to provide some of the functionalities described herein. The computer-readable medium 204 also includes an audio-based application 206, which passes the audio content 122 to the hearable 102 and optionally accepts other audio content from the hearable 102. For example, the audio-based application 206 can be a music application that provides music to the hearable 102. In another example, the audio-based application 206 can be a movie application that provides sound from a motion picture to the hearable 102. In yet another example, the audio-based application 206 can be a phone application that provides a caller's voice to the hearable 102.

The computing device 104 can also include a network interface 208 for communicating data over wired, wireless, or optical networks. For example, the network interface 208 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The computing device 104 may also include a display 210. In some implementations, the hearable 102 can be integrated within the computing device 104, or can connect physically or wirelessly to the computing device 104. The hearable 102 is further described with respect to FIG. 3.

FIG. 3 illustrates an example hearable 102. The hearable 102 is illustrated with various non-limiting example devices, including wireless earbuds 302-1, wired earbuds 302-2, and headphones 302-3, which can be wireless or wired. An earbud 302-1 or 302-2 is a type of in-ear device that fits, at least partially, into the ear canal 110. Each earbud 302-1 or 302-2 can represent a hearable 102. Headphones 302-3 can rest on top of or over the ears 108. The headphones 302-3 can represent closed-back headphones, open-back headphones, on-ear headphones, or over-ear headphones. Some headphones 302-3 include two hearables 102, which are physically packaged together. In this case, there is one hearable 102 for each ear 108. Other headphones 302-3, such as single-ear headphones, include one hearable 102.

The hearable 102 includes a communication interface 304 to communicate with the computing device 104, though this need not be used when the hearable 102 is integrated within the computing device 104 or implemented as a stand-alone device. The communication interface 304 can be a wired interface or a wireless interface, in which audio content is passed from the computing device 104 to the hearable 102 and/or vice versa. The hearable 102 can also use the communication interface 304 to pass information to the computing device 104. In general, the data provided by the communication interface 304 is in a format usable by the audio-based application 206. The communication interface 304 can also enable the hearable 102 to communicate with another hearable 102 (e.g., another one of the earbuds 302-1 or 302-2 or another hearable that is part of the headphones 302-3).

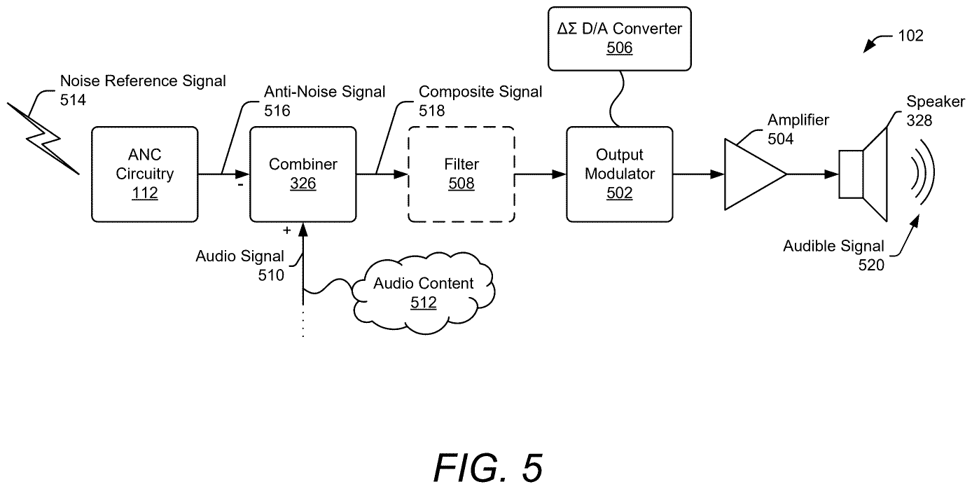

The hearable 102 also includes the active-noise-cancellation circuity 112, which enables the hearable 102 to reduce background or environmental noise heard by the user 106. In particular, the active-noise-cancellation circuitry 112 generates an anti-noise signal, which can attenuate noise that is present at the ear 108 of the user 106. The anti-noise signal is further explained with respect to FIG. 5. The active-noise-cancellation circuitry 112 includes at least one microphone 306, at least one processing circuit 308, and at least one control circuit 310.

The microphone 306, or more generally a transducer, converts sound waves into electrical signals. In some implementations, the microphone 306 is oriented towards an external environment to receive acoustic signals that include background noise.

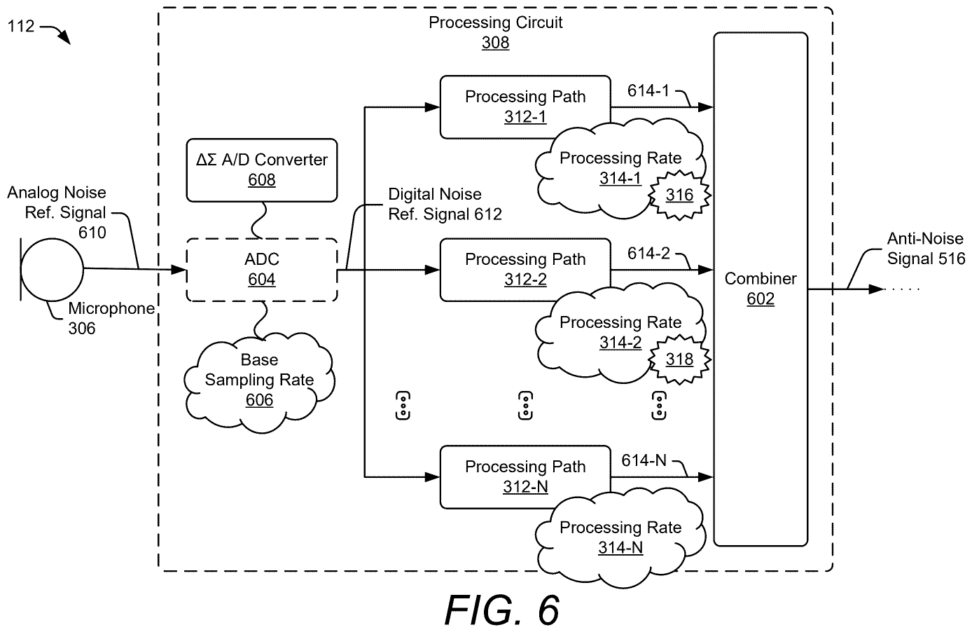

The processing circuit 308 includes circuitry and logic for conditioning electrical signals in a digital domain. Example implementations of the processing circuit 308 are further described with respect to FIGS. 6 and 8-10. In some implementations, components of the processing circuit 308 can be implemented or packaged as part of the microphone 306. An example component includes an analog-to-digital converter, which can be implemented as part of the microphone 306 or can be implemented as a distinct component that is separate from the microphone 306.

The processing circuit 308 includes at least two processing paths 312-1 to 312-N, where N represents a positive integer greater than or equal to two. Each processing path 312-1 to 312-N is associated with a different processing rate 314, as further described with respect to FIG. 6. Example processing rates 314 can be categorized as a responsive processing rate 316 (responsive PR 316) or a power-efficient processing rate 318 (power-efficient PR 318). Generally, a responsive processing rate 316 is faster than a power-efficient processing rate 318.

Responsive processing rates 316, which can also be referred to as “fast” processing rates, include processing rates that improve responsiveness (e.g., reduce latency) for active noise cancellation 114. In general, a responsive processing rate 316 is similar to (or in some cases equal to) a sampling rate of a digital noise signal that is provided as an input signal to a processing path 312. In some implementations, a responsive processing rate 316 is greater than or equal to approximately 50% of the sampling rate of the digital noise signal (e.g., greater than or equal to 50%, 60%, 70%, 75%. 80%, 90%, 98%, or 100%). The term “approximately” can mean that the responsive processing rate 316 is within ±2% of a specified value. A processing path 312 that utilizes the responsive processing rate 316 can be more responsive (e.g., introduce less latency) compared to another processing path 312 that utilizes the power-efficient processing rate 318.

Power-efficient processing rates 318, which can also be referred to as “slow” processing rates, include processing rates that improve power efficiency (e.g., consume less power) for active noise cancellation 114. In general, a power-efficient processing rate 318 is significantly slower than the sampling rate of the original digital noise reference signal. In some implementations, a power-efficient processing rate 318 is less than approximately 50% of the sampling rate of the digital noise signal (e.g., less than or equal to 50%, 40%, 30%, 20%, 10%, 5%, or 1%). The term “approximately” can mean that the power-efficient processing rate 318 is within ±2% of a specified value. A processing path 312 that utilizes the power-efficient processing rate 318 can be more efficient (e.g., consume less power) compared to another processing path 312 that utilizes the responsive processing rate 316.

In an example implementation, the responsive processing rate 316 is at least two times larger than the power-efficient processing rate 318 (e.g., 4, 8, 16, 32, or 64 times larger). Consider an example in which the responsive processing rate 316 is between approximately 1 and 4 megahertz (MHz). In this example, the power-efficient processing rate 318 can be between approximately 15 kilohertz (kHz) and 2 MHz. Consider another example in which the responsive processing rate 316 is approximately 3.072 MHz. In this example, the power-efficient processing rate 318 can be between approximately 1.536 MHz and 48 kHz (e.g., can be approximately equal to 1,536, 768, 384, 192, 96, or 48 kilohertz (kHz)).

The processing circuit 308 can utilize a set of processing rates 314, which includes a subset of responsive processing rates 316 and a subset of power-efficient processing rates 318. These subsets are proper subsets. The subset of responsive processing rates 316 at least includes a fastest one of the processing rates 314. In some implementations, the subset of responsive processing rates 316 includes multiple processing rates 314 that are faster than the processing rates 314 within the subset of power-efficient processing rates 318. Also, the subset of power-efficient processing rates 318 at least includes a slowest one of the processing rates 314. In some implementations, the subset of power-efficient processing rates 318 includes multiple processing rates 314 that are slower than the processing rates 314 within the subset of responsive processing rates 316.

The multiple processing rates 314 associated with the multiple processing paths 312 improve a power efficiency of the hearable 102 without significantly reducing accuracy or increasing latency. This is because at least one of the processing paths 312 is associated with the responsive processing rate 316 and at least another one of the processing paths 312 is associated with the power-efficient processing rate 318. The processing path 312 with the responsive processing rate 316 functions to improve accuracy and reduce latency while the other processing path 312 with the power-efficient processing rate 318 functions to improve power efficiency. With the multiple processing rates 314, the active-noise-cancellation circuitry 112 can avoid the tradeoff between responsiveness and power efficiency that is associated with a single processing rate and instead be optimized for both responsiveness and power efficiency. In this way, the described techniques for multi-rate processing enables the active-noise-cancellation circuitry 112 to realize both a target level of responsiveness and a target power efficiency.

In some example implementations, the processing circuit 308 can impact system latency by less than approximately 5 microseconds (μs) (e.g., less than approximately 1 or 0.5 μs) for an input signal with a sampling rate of approximately 3 megahertz (MHz). The term “approximately” can mean that the impact to latency can be within ±5% of a specified value. This means that other components of the hearable 102 may contribute more to the system latency than the processing circuit 308. Example components that can introduce latency include the microphone 306, the speaker 328, and/or an amplifier (e.g., amplifier 504 in FIG. 5).

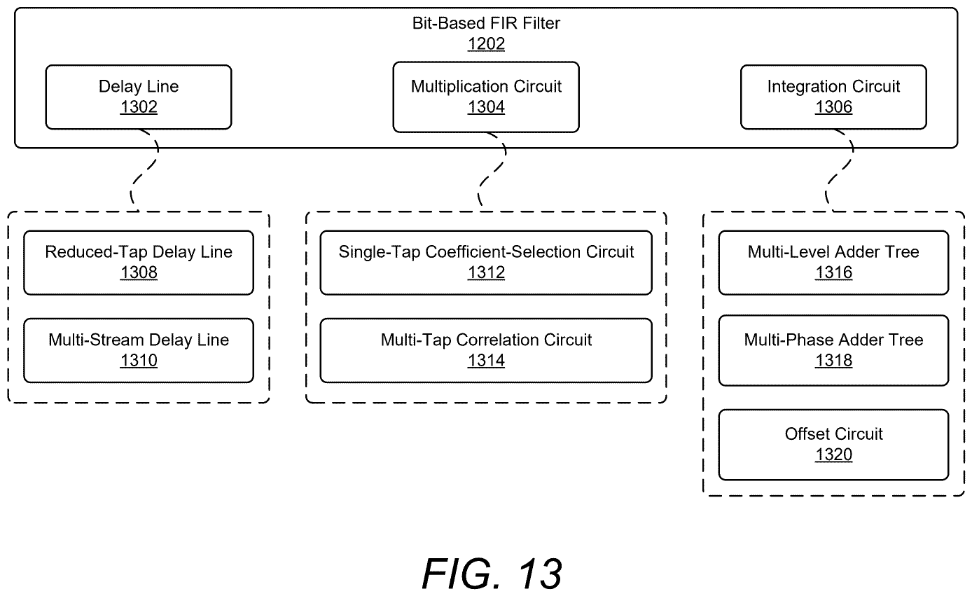

Optionally, some of the processing paths 312-1 to 312-N can be associated with a different domain 320, such as a pulse-density-modulation (PDM) domain 322 (PDM domain 322) or a pulse-code-modulation (PCM) domain (PCM domain 324). A processing path 312 associated with the pulse-density-modulation domain 322 performs operations (e.g., filtering) on individual bits of an input digital noise signal (e.g., on a bit-by-bit basis or on one bit at a time). The binary bits can be interpreted as corresponding to a +1 or a −1 value. In some cases, the processing path 312 associated with the pulse-density-modulation domain 322 is implemented in a manner that conserves power, as further described with respect to FIGS. 13-16.

In contrast, the one or more processing paths 312 associated with the pulse-code-modulation domain 324 perform operations (e.g., filtering) on multiple bits of the noise signal (e.g., at a multi-bit word level, on a word-by-word basis, or on multiple bits at a time). In some example implementations, the multiple bits are processed in groups of 16 bits, 24 bits, or 32 bits.

The term pulse-density-modulation domain 322 can also be referred to as a pulse-density-modulation scheme or a pulse-density modulation. The term pulse-code-modulation domain 324 can also be referred to as a pulse-code-modulation scheme or a pulse-code modulation. Generally speaking, the pulse-density-modulation domain 322 and the pulse-code-modulation domain 324 are different systems or ways in which a sampled signal is represented or processed in a stream.

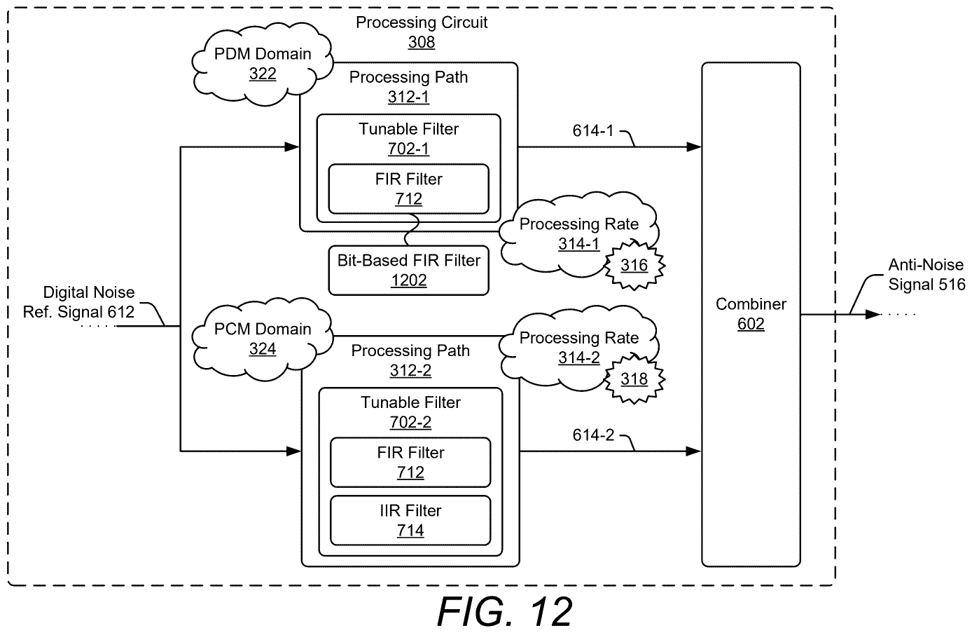

In some implementations, the at least one processing path 312 associated with the responsive processing rate 316 is also associated with the pulse-density-modulation domain 322. Additionally or alternatively, the one or more processing paths 312 associated with the power-efficient processing rate 318 are also associated with the pulse-code-modulation domain 324. An example implementation of the active-noise-cancellation circuitry 112 including multiple domains 320 is further described with respect to FIG. 12. The pulse-density-modulation domain 322 enables techniques for bit-based finite-impulse-response filtering to be applied to further improve power efficiency while the pulse-code-modulation domain 324 provides additional design flexibility.

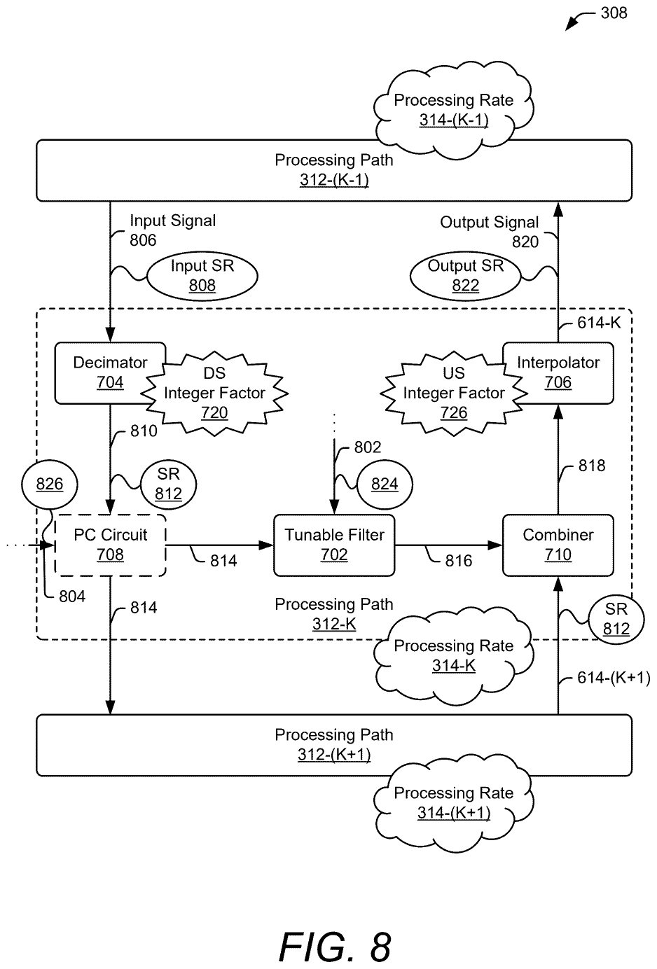

The control circuit 310 can configure and/or control an operation of the processing circuit 308. In some implementations, the control circuit 310 configures parameters associated with each of the processing paths 312. These parameters can include filter coefficients and/or delays, as further described with respect to FIG. 8.

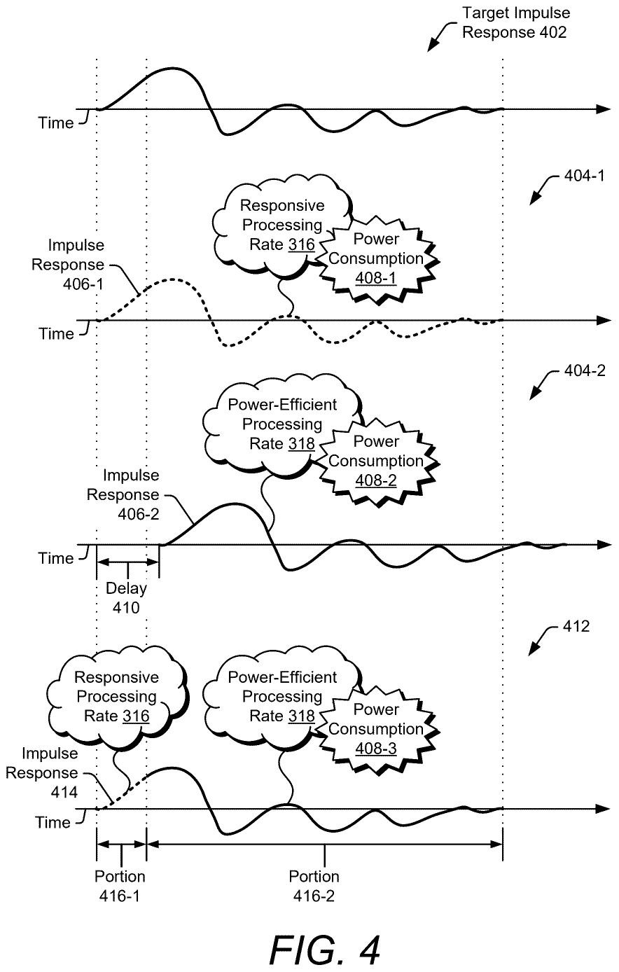

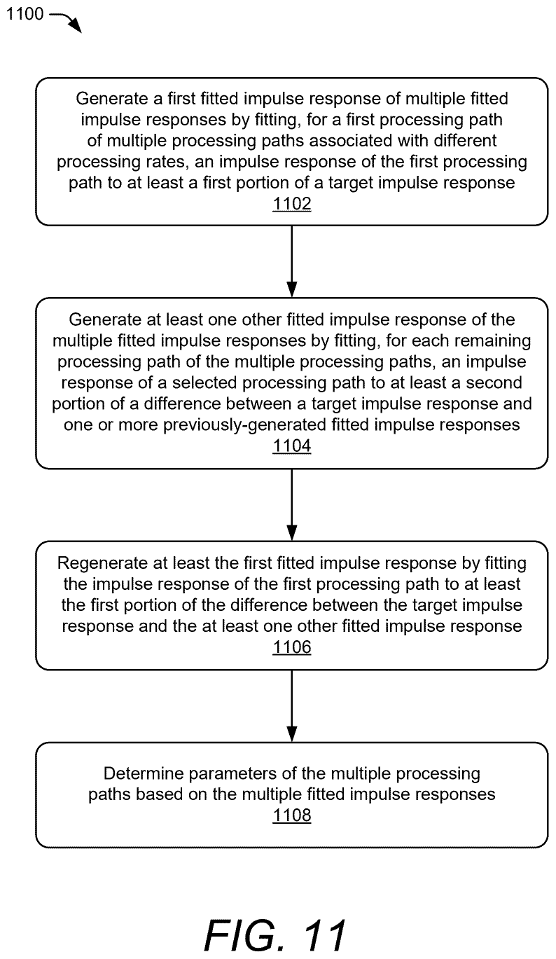

In general, the control circuit 310 configures parameters of the processing circuit 308 to enable an impulse response of the processing circuit 308 to approximate a target impulse response, as further described with respect to FIG. 4. In some implementations, the control circuit 310 and the processing circuit 308 can perform a calibration process to determine the appropriate parameters. The calibration process is further described with respect to FIG. 11. The processing circuit 308 and/or the control circuit 310 can be implemented using hardware, software, firmware, or a combination thereof.

The hearable 102 also includes at least one combiner 326 and at least one speaker 328 (or at least one transducer). The combiner 326 combines the anti-noise signal generated by the active-noise-cancellation circuitry 112 with a signal that includes the audio content 122 to generate a signal that is provided to the speaker 328, as further described with respect to FIG. 5.

The speaker 328 converts electrical signals into sound waves. These sound waves may include audible frequencies between approximately 20 hertz (Hz) and 20 kilohertz (kHz). The speaker 328 can be oriented towards the ear canal 110 to direct acoustic signals towards the ear canal 110.

Although not explicitly shown, some implementations of the hearable 102 can include at least one power source, such as a battery or battery pack. In some implementations, the battery can be rechargeable. Other implementations of the hearable 102 can be powered through wireless power transfer (e.g., inductive charging) or wired power transfer (e.g., via a wired connection). With multi-rate processing, the different processing rates 314 associated with different processing paths 312 contribute to different portions of an impulse response of the active-noise-cancellation circuitry 112, as further described with respect to FIG. 4.

FIG. 4 illustrates example impulse responses for active noise cancellation 114. A target impulse response 402 for active noise cancellation 114 is shown at the top of FIG. 4. This represents a desired impulse response that achieves a target level of performance for active noise cancellation 114. Without the techniques for multi-rate processing, other implementations of active-noise-cancellation circuitry utilize a single processing rate. The performance of these single-processing-rate implementations are further described at 404-1 and 404-2.

At 404-1, a first example single-processing-rate implementation of active-noise-cancellation circuitry uses the responsive processing rate 316 as the single processing rate. The responsive processing rate 316 enables the active-noise-cancellation circuitry in this first example to have an impulse response 406-1 that approximates the target impulse response 402 with little latency. However, the responsive processing rate 316 also causes the active-noise-cancellation circuitry in this first example to consume a significant amount of power, as indicated at 408-1. This power consumption 408-1 can significantly drain a power source of the hearable 102 and cause the user 106 to recharge the hearable 102 more frequently compared to a second example single-processing-rate implementation described below.

At 404-2, a second example single-processing-rate implementation of active-noise-cancellation circuitry uses the power-efficient processing rate 318 as the single processing rate. Because the power-efficient processing rate 318 is slower than the responsive processing rate 316, the active-noise-cancellation circuitry in this second example can conserve power relative to the active-noise-cancellation circuitry in the first example. As such, power consumption 408-2 of this active-noise-cancellation circuitry can be significantly less than the power consumption 408-1 at 404-1. The power-efficient processing rate 318, however, causes the active-noise-cancellation circuitry to have an impulse response 406-2 that is delayed relative to the target impulse response 402, as indicated by delay 410. This delay 410 can significantly degrade the performance of the hearable 102 for active noise cancellation 114.

At 412, performance of active-noise-cancellation circuitry 112 that utilizes at least one responsive processing rate 316 and at least one power-efficient processing rate 318 is shown. In this case, the active-noise-cancellation circuitry 112 has an impulse response 414. A processing path 312 associated with the responsive processing rate 316 contributes to a first portion 416-1 (or a beginning portion) of the impulse response 414, which is shown using a dashed line. This enables the active-noise-cancellation circuitry 112 to be responsive and experience less latency compared to the impulse response 406-2 of the second single-processing-rate implementation described at 404-2. Another processing path 312 associated with the power-efficient processing rate 318 contributes to a second portion 410-2 (or an ending portion) of the impulse response 414. This enables the active-noise-cancellation circuitry 112 to conserve power. In general, a time interval associated with the second portion 410-2 is significantly greater than a time interval associated with the first portion 410-1 to improve power efficiency. As such, power consumption 408-3 of the active-noise-cancellation circuitry 112 at 412 can be significantly less than the power consumption 408-1 at 404-1. Furthermore, the second path may be fully programmable enabling a wider range of responses to different audio scenarios without modifying the hardware.

Some implementations of the active-noise-cancellation circuitry 112 at 412 can also utilize techniques for implementing multi-domain processing and/or bit-based finite-impulse-response processing. With one or both of these techniques, the active-noise-cancellation circuitry 112 at 412 can have the power consumption 408-3 approach the power consumption 408-2 at 404-2. With multiple processing paths 312 associated with different processing rates 314, the active-noise-cancellation circuitry 112 described at 412 can attenuate noise with a high degree of responsiveness and power efficiency. An operation of the hearable 102 is further described with respect to FIG. 5.

FIG. 5 illustrates example components of the hearable 102, which can perform multi-rate processing for active noise cancellation 114. In the depicted configuration, the hearable 102 includes the active-noise-cancellation circuitry 112, the combiner 326, an output modulator 502, at least one amplifier 504, and the speaker 328. The hearable 102 can also include other components that are not explicitly shown in FIG. 5, such as a hard limiter and/or an H-bridge.

The combiner 326 is coupled to an output of the active-noise-cancellation circuitry 112. The output modulator 502 is coupled between the combiner 326 and the amplifier 504. The amplifier 504 is coupled between the output modulator 502 and the speaker 328. The amplifier 504 can amplify and/or attenuate analog signals to adjust a volume associated with the speaker 328.

The output modulator 502 performs analog-to-digital conversion. In some implementations, the output modulator 502 is implemented as a delta-sigma (ΔΣ) digital-to-analog converter 506 (ΔΣ D/A converter 506). Although the output modulator 502 and the amplifier 504 are shown as distinct components that are separate from the speaker 328 in FIG. 5, other implementations are also possible in which the output modulator 502 and/or the amplifier 504 are integrated within the speaker 328.

Some implementations of the output modulator 502, including the delta-sigma digital-to-analog converter 506, can be sensitive to out-of-band noise. In some cases, the out-of-band noise is generated by the active-noise-cancellation circuitry 112 and/or the combiner 326. To address this, the hearable 102 can optionally include at least one filter 508 (e.g., at least one post-processing filter), which can attenuate the out-of-band noise. The filter 508 is coupled between the combiner 326 and the output modulator 502. With the filter 508, the hearable 102 can reduce a noise floor to improve the performance of other components within the hearable 102, such as the output modulator 502.

The filter 508 can be implemented as a low-pass filter using a finite-impulse-response (FIR) filter or using an infinite-impulse-response (IIR) filter. The infinite-impulse-response filter can have a lower latency compared to the finite-impulse-response filter in some cases. Some higher-ordered finite-impulse-response filters, however, can emulate a response of an infinite-impulse-response filter. The filter 508 can be designed to attenuate the out-of-band noise while impacting latency of the hearable 102 by less than approximately 5 μs (e.g., by less than approximately 3 or 1 μs). The term “approximately” can mean that the impact to latency can be within ±10% of a specified value. A bandwidth of the filter 508 can be between approximately 100 and 400 kilohertz in some implementations. In an example implementation, the filter 508 includes a digital lattice-wave filter, which can conserve power by avoiding multiplication operations.

In some aspects, the filter 508 can be designed to reduce a crest factor of signals that are provided to the speaker 328. This enables the hearable 102 to improve active noise cancellation 114 in loud environments. Other techniques are also possible to reduce the crest factor, including the techniques for implementing bit-based finite-impulse-response filtering, as further described with respect to FIG. 13.

During an operation of the hearable 102, the hearable 102 generates an audio signal 510. The audio signal 510 includes audio content 512 (e.g., the audio content 122 of FIG. 1), which can be provided by the audio-based application 206 of the computing device 104. In an example implementation, the communication interface 304 generates the audio signal 510.

While the audio signal 510 is generated, the active-noise-cancellation circuitry 112 receives (or detects) noise reference signal 514 (e.g., noise 116 of FIG. 1 or noise signal) using the microphone 306. The noise reference signal 514 includes environmental or background noise, which is present at the user 106's ear 108. The active-noise-cancellation circuitry 112 generates an anti-noise signal 516 based on the noise reference signal 514. The anti-noise signal 516 can attenuate at least some frequency components of the noise reference signal 514. Although the anti-noise signal 516 is shown as a single signal in FIG. 5 for simplicity, the anti-noise signal 516 can represent multiple anti-noise signals (or multiple anti-noise component signals).

The combiner 326 generates a composite signal 518 based on the anti-noise signal 516 and the audio signal 510. For example, the combiner 326 can combine the anti-noise signal 516 and the audio signal 510 together using addition or subtraction (as shown in FIG. 5). In general, the anti-noise signal 516 is combined with the desired audio signal 510 in such a way that a component of the composite signal 518 that is associated with the anti-noise signal 516 has a phase that is substantially opposite a phase of the noise as represented by reference signal 514 (e.g., approximately 180 degrees offset from the phase of the noise reference signal 514). The term “approximately” can mean that the phase can be within ±5% of a specified value within a certain frequency band.

The filter 508 filters the composite signal 518 to attenuate the out-of-band noise, and the output modulator 502 converts the filtered composite signal 518 from a digital domain to an analog domain. The amplifier 504 amplifies the analog version of the filtered composite signal 518. The speaker 328 generates an audible signal 520 based on a signal provided by the amplifier 504. A component of the audible signal 520 that is associated with the anti-noise signal 516 can attenuate the noise as represented by noise reference signal 514 that is present at the user 106's ear 108. Another component of the audible signal 520 that is associated with the audio signal 510 provides the audio content 512 to the user 106.

In FIG. 5, the hearable 102 is shown to include a single instance of the active-noise-cancellation circuitry 112. Other implementations are also possible in which multiple instances of the active-noise-cancelation circuitry 112 operate in parallel and are coupled to the combiner 326. The multiple processing paths 312 of the active-noise-cancellation circuitry 112 are further described with respect to FIG. 6.

### Multi-Rate Processing for Active Noise Cancellation

FIG. 6 illustrates example active-noise-cancellation circuitry 112 having multiple processing paths 312-1, 312-2 . . . 312-N respectively associated with multiple processing rates 314-1, 314-2 . . . 314-N. In the depicted configuration, the active-noise-cancellation circuitry 112 includes the microphone 306 and the processing circuit 308. The processing circuit 308 is coupled between the microphone 306 and other components of the hearable 102, such as the combiner 326 shown in FIG. 5. The processing circuit 308 includes the processing paths 312-1 to 312-N and at least one combiner 602.

In some implementations, the processing circuit 308 also includes an analog-to-digital converter 604, as shown in FIG. 6. In other implementations, the analog-to-digital converter 604 can be integrated within the microphone 306. The analog-to-digital converter 604 performs analog-to-digital conversion in accordance with a base sample rate 606 (or an initial sampling rate). In an example implementation, the base sampling rate 606 is between approximately 1 and 4 MHz (e.g., between approximately 2 and 3 MHz, between approximately 3 and 4 MHz, or approximately equal to 3.072 MHz). The term “approximately” can mean that the base sampling rate 606 can be within ±25% of a specified value.

The analog-to-digital converter 604 can be implemented using a variety of different types of analog-to-digital converters 604. In a first example, the analog-to-digital converter 604 is implemented as a delta-sigma (ΔΣ) analog-to-digital converter 608. In a second example, the analog-to-digital converter 604 is implemented as a direct sampling converter, such as a Nyquist-type analog-to-digital converter (not shown in FIG. 6). The direct sampling converter can have less latency and less noise-shaping properties compared to the delta-sigma analog-to-digital converter 608. However, the direct sampling converter can be more expensive and challenging to implement in silicon compared to the delta-sigma analog-to-digital converter 608.

The processing paths 312-1 to 312-N are respectively associated with different processing rates 314-1 to 314-N. More specifically, a first processing path 312-1 is associated with a first processing rate 314-1. A second processing path 312-2 is associated with a second processing rate 314-2. An N^{th} processing path 312-N is associated with an N^{th} processing rate 314-N. To provide responsiveness, at least one of the processing rates 314 is a responsive processing rate 316. To conserve power, at least another one of the processing rates 314 is a power-efficient processing rate 318. In general, at least one of the processing paths 312 is associated with the responsive processing rate 316 and at least another one of the processing paths 312 is associated with the power-efficient processing rate 318.

Generally speaking, the processing rates 314 represent corresponding frequencies (e.g., sampling rates) of signals (e.g., versions of the noise reference signal 514) that are processed (e.g., filtered) by the processing paths 312, as further described with respect to FIG. 8. A processing rate 314 is considered to be a responsive processing rate 316 or a power-efficient processing rate 318 based on the base sampling rate 606 of a digital version of the noise reference signal 514 (e.g., the digital noise reference signal 612). In general, a responsive processing rate 316 is similar to (or in some cases equal to) the base sampling rate 606. In some implementations, a responsive processing rate 316 is greater than or equal to approximately 50% of the base sampling rate 606 of the digital version of the noise reference signal 514 (e.g., greater than or equal to 50%, 60%, 70%, 75%. 80%, 90%, 98%, or 100%). In contrast, a power-efficient processing rate 318 is significantly slower than the base sampling rate 606. In some implementations, a power-efficient processing rate 318 is less than approximately 50% of the base sampling rate 606 of the digital version of the noise reference signal 514 (e.g., less than or equal to 50%, 40%, 30%, 20%, 10%, 5%, or 1%).

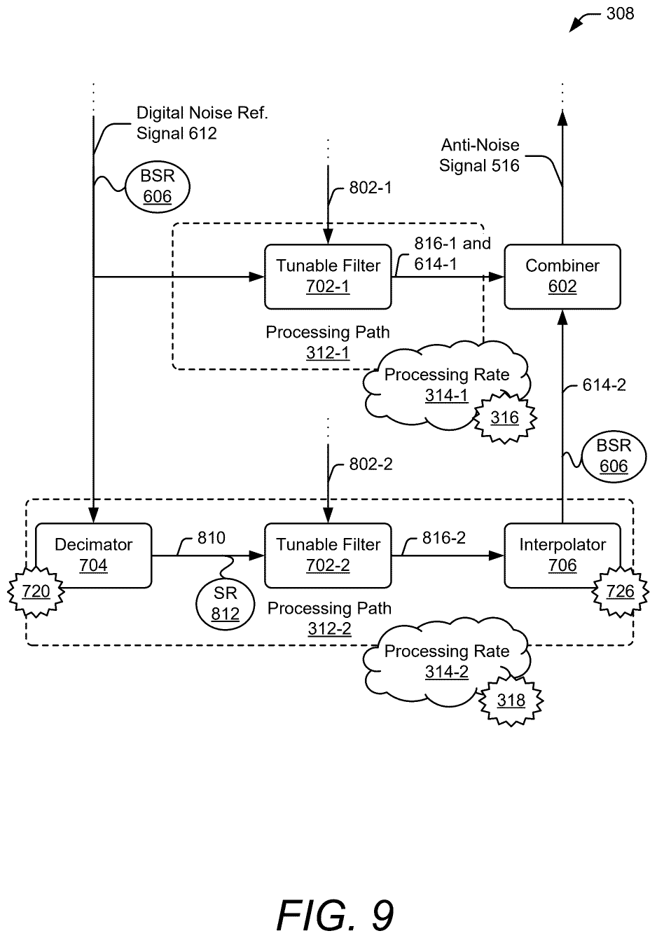

Consider an example in which the processing circuit 308 includes two processing paths 312. In this example, the processing rate 314-1 can be the responsive processing rate 316 and the processing rate 314-2 can be the power-efficient processing rate 318, as indicated in FIG. 6. An example implementation of the processing circuit 308 with two processing paths 312 is further described with respect to FIG. 9.

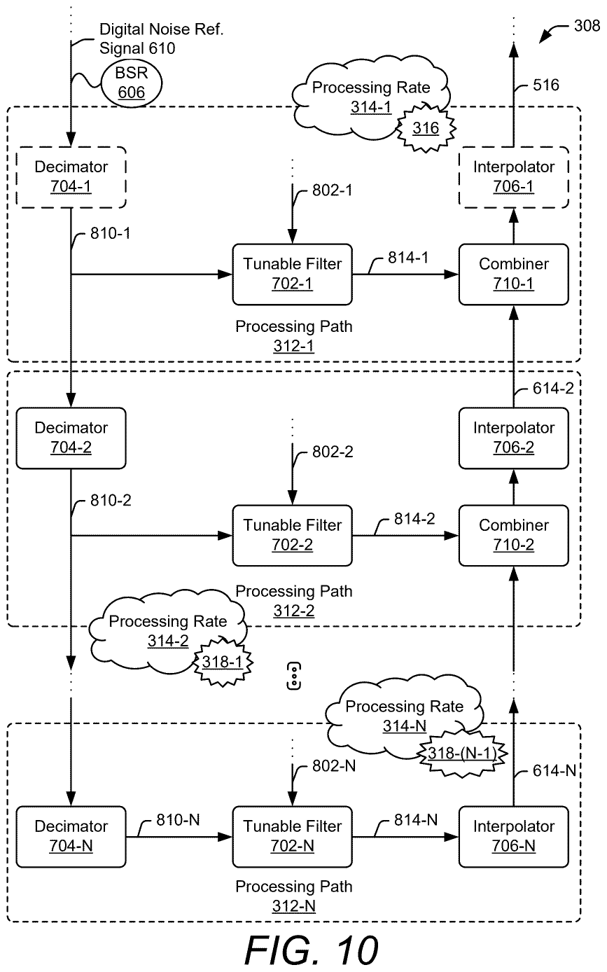

In another example, the processing circuit 308 includes more than two processing paths 312. In this example, the processing rate 314-1 can be the responsive processing rate 316, and the processing rates 314-2 to 312-N can be power-efficient processing rates 318. An example implementation of the processing circuit 308 with multiple processing paths 312 is further described with respect to FIG. 10. Other examples are also possible in which two or more of the processing rates 314 are responsive processing rates 316.

In this example, the combiner 602 is implemented as a single component (e.g., a single combiner), and the outputs of the processing paths 312-1 to 312-N are coupled to inputs of the combiner 602. The combiner 602 can be implemented as a single component, an example of which is shown in FIG. 9. Alternatively, the combiner 602 can be implemented using multiple components (e.g., multiple combiners), which are distributed within the processing paths 312-1 to 312-N. An example implementation of the combiner 602 implemented using multiple components is further described with respect to FIG. 10. In still other implementations, the combiner 602 represents the combiner 326 of FIG. 5 and includes another input (not shown) that accepts the audio signal 510.

In FIG. 6, the processing paths 312-1 to 312-N are shown to be coupled in parallel between the analog-to-digital converter 604 and the combiner 602. An example parallel implementation is further described with respect to FIG. 9. Other implementations are also possible in which at least one of the processing paths 312 has an input coupled to a first component within another processing path 312 and has an output coupled to a second component within the other processing path 312. This tiered implementation can help improve power efficiency, as further described with respect to FIGS. 8 and 10.

During operation, the microphone 306 receives the noise reference signal 514 and generates an analog noise reference signal 610 (analog noise ref. signal 610) based on the noise reference signal 514. In this example, the analog noise reference signal 610 represents an analog signal that is generated by the microphone 306. The analog-to-digital converter 604 generates a digital noise reference signal 612 (digital noise ref. signal 612) based on the analog noise reference signal 610. The digital noise reference signal 612 has a sampling rate equal to the base sampling rate 606 of the analog-to-digital converter 604. If the analog-to-digital converter 604 is implemented within the microphone 306, the microphone 306 can provide the digital noise reference signal 612 directly to the processing circuit 308.

The processing paths 312-1 to 312-N respectively generate anti-noise signal components 614-1 to 614-N based on the digital noise reference signal 612. At least one of the processing rates 314 is slower than the base sampling rate 606 to enable the active-noise-cancellation circuitry 112 to conserve power. As such, at least one of the processing paths 312-1 to 312-N decimates the digital noise reference signal 612 to a lower sampling rate such that the decimated signal can be processed at the corresponding processing rate 314. The use of a lower and more efficient sampling rate may also enable a larger degree of flexibility in the filtering process.

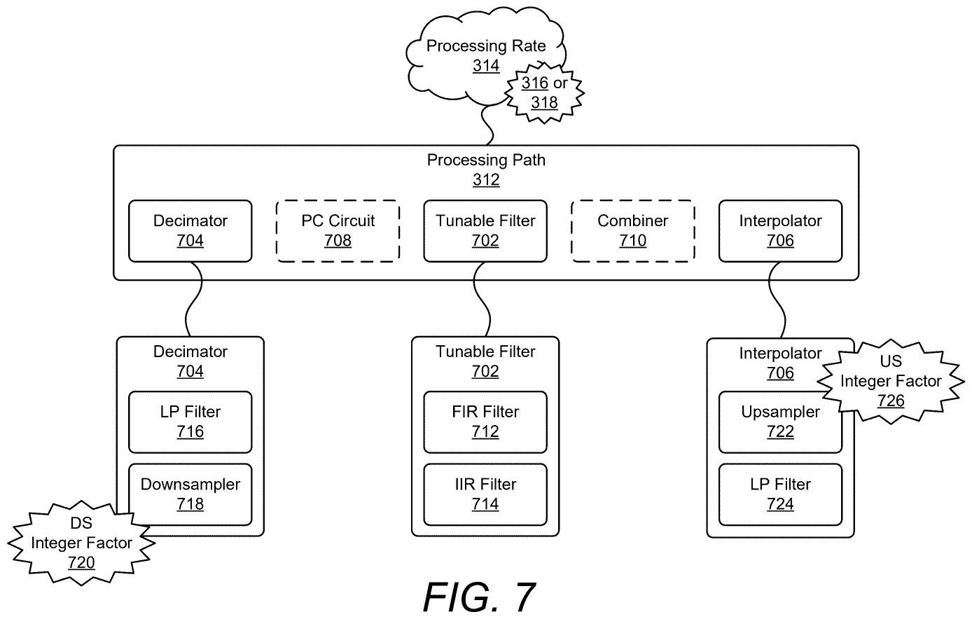

The processing performed by the processing paths 312-1 to 312-N occurs at different processing rates 314 during a same time interval. This enables the active-noise-cancellation circuitry 112 to be both responsive and efficient. The combiner 602 combines the anti-noise signal components 614-1 to 614-N to generate the anti-noise signal 516. The components of the processing paths 312-1 to 312-N are further described with respect to FIG. 7.

FIG. 7 illustrates example components of a processing path 312. The processing path 312 has a processing rate 314, which can be a responsive processing rate 316 or a power-efficient processing rate 318. Each processing path 312 within the processing circuit 308 includes at least one tunable filter 702. At least one processing path 312 within the processing circuit 308 includes a decimator 704 (e.g., a decimation circuit or a decimation filter) and an interpolator 706 (e.g., an interpolation circuit or an interpolation filter). The decimator 704 and the interpolator 706 are further described below.

The processing path 312 can optionally include a phase-correction circuit 708 (PC circuit 708) (e.g., a delay circuit) and/or a combiner 710. The phase-correction circuit 708 enables the processing paths 312 to be aligned in phase. In particular, the phase-correction circuit 708 can compensate for any delays in a corresponding processing path 312. The delay can be caused, at least in part, by the decimator 704 and/or the interpolator 706. The phase-correction circuit 708 can also ensure that a group delay is flat within a certain band of interest.

Various implementations of the phase-correction circuit 708 can provide an integer delay or a fractional delay. Although the phase-correction circuit 708 is illustrated as a separate component in FIG. 7, other implementations can integrate the phase-correction circuit 708 within or as part of the tunable filter 702. In some implementations, the phase-correction circuit 708 is implemented as an all-pass filter.

The combiner 710 can represent one of multiple components that form the combiner 602 shown in FIG. 6. The combiner 710 enables signals associated with two processing paths 312 to be combined, as shown in FIGS. 8 to 10.

A processing path 312 associated with a responsive processing rate 316 can optionally include the decimator 704 and the interpolator 706. The processing path 312-1 shown in FIG. 9, for instance, is implemented without the decimator 704 and the interpolator 706. Other implementations are also possible in which the processing path 312 associated with the responsive processing rate 316 includes the decimator 704 and the interpolator 706. One such example is shown in FIG. 10.

A processing path 312 associated with a power-efficient processing rate 318 at least includes the decimator 704 and the interpolator 706. The processing path 312-2 shown in FIGS. 9 and 10, for instance, includes the decimator 704 and the interpolator 706. With the advantages of multi-rate processing, system requirements regarding latency of the decimator 704 and the interpolator 706 can be relaxed, which can further reduce a cost of the processing circuit 308 compared to other types of processing circuits.

The tunable filter 702 can be implemented using at least one finite-impulse-response filter 712 (FIR filter 712) or at least one infinite-impulse-response filter 714 (IIR filter 714), or some combination thereof. A response of the tunable filter 702 can be adjusted (e.g., tuned) by the control circuit 310 based on a calibration process. This enables the active-noise-cancellation circuitry 112 to achieve an impulse response 412 that is similar to the target impulse response 402. The calibration process is further described with respect to FIG. 11. In some implementations, the tunable filter 702 is implemented using a digital lattice wave filter, which can reduce power consumption relative to other types of filters by replacing multiplication operations with additions and/or subtraction operations. In other implementations, the tunable filter 702 may consist of a combination of low-power filters such as infinite-impulse-response filters, BiQuads filters, or finite-impulse-response filters based on the pulse-density-modulation domain 322, where the input values are binary.

The decimator 704 performs decimation, which reduces a sampling rate of an input signal. To reduce the sampling rate, the decimator 704 can perform low-pass filtering and discard samples of the input signal, which is referred to as downsampling. In an example implementation, the decimator 704 is implemented using at least one low-pass filter 716 (LP filter 716) and at least one downsampler 718. The downsampler 718 has an input that is coupled to an output of the low-pass filter 716. The low-pass filter 716 filters the input signal to generate a filtered signal. The downsampler 718 downsamples the filtered signal to generate a decimated signal.

The downsampler 718 is associated with a downsampling integer factor 720 (DS integer factor 720). The downsampling integer factor 720 determines which samples of the filtered signal pass through the downsampler 718 (e.g., which samples of the filtered signal are outputted) and which samples of the filtered signal are discarded. Consider an example in which the downsampling integer factor 720 has a value represented by variable M, which is a positive integer. In accordance with the downsampling integer factor 720, the downsampler 718 keeps every Mth sample of the filtered signal and discards the other samples. Accordingly, the decimated signal outputted by the decimator 704 has a sampling rate that is equal to the sampling rate of the input signal divided by the downsampling integer factor 720.

The downsampling integer factor 720 is set to a value that causes the decimated signal to have a sampling rate that is equal to the processing rate 314 of the processing path 312. By reducing the sampling rate of the input signal to the processing rate 314, the decimator 704 reduces the computational cost and power consumption associated with processing the input signal. In general, it is cheaper, easier, and more efficient to perform processing at a slower processing rate than at a faster processing rate. This can result in a lower requirement for the coefficient word lengths, which may require a very high precision for low cutoff frequencies when a high sampling rate is used. Thus, both the processing rate and the computational requirements can be much less at lower sampling rates.

The interpolator 706 performs interpolation, which increases a sampling rate of a signal. To increase the sampling rate, the interpolator 706 can insert samples (e.g., samples equal to zero) into an incoming signal, which is referred to as upsampling. The interpolator 706 can also perform low-pass filtering to interpolate across the newly added samples. By performing the low-pass filtering, the aliased mirror images of the original spectrum are attenuated. In an example implementation, the interpolator 706 is implemented using an upsampler 722 and a low-pass filter 724. The low-pass filter 724 has an input that is coupled to an output of the upsampler 722. The upsampler 722 inserts zeros between samples of the incoming signal to generate an upsampled signal. The low-pass filter 724 filters the upsampled signal to generate an interpolated signal.

The upsampler 722 is associated with an upsampling integer factor 726 (US integer factor 726). The upsampling integer factor 726 specifies a quantity of samples that are inserted between two consecutive samples of the incoming signal. Consider an example in which the upsampling integer factor 726 has a value represented by variable L, which is a positive integer. In accordance with the upsampling integer factor 726, the upsampler 722 inserts L-1 samples after each sample of the incoming signal. Accordingly, the upsampled signal outputted by the interpolator 706 has a sampling rate that is equal to the sampling rate of the incoming signal (e.g., equal to the processing rate 314) multiplied by the upsampling integer factor 726.

The upsampling integer factor 726 can be set to a value that causes the interpolated signal to have a sampling rate that is equal to the sampling rate of an input signal provided to the decimator 704. By increasing the sampling rate, the interpolator 706 effectively nullifies the slower sampling rate applied by the decimator 704. Also, the decimator 704 itself enables the signal to be processed at a lower and more efficient sampling rate, provided the bandwidth is sufficiently large. As such, the processing path 312 can output a signal with a same sampling rate as an input signal.

The decimator 704 and the interpolator 706 can be implemented using a single stage, as shown in FIG. 9. Other implementations are also possible in which the decimator 704 and/or the interpolator 706 within a processing path 312 are implemented using multiple stages. By using multiple stages, the decimator 704 and/or the interpolator 706 can be implemented with a smaller footprint and can consume less power compared to a single-stage implementation. An example multistage implementation is further described with respect to FIG. 10.

Higher quality low-pass filters 716 and 724 can be used to implement the decimator 704 and the interpolator 706. These filters can improve out-of-band noise and signal-to-noise-ratio performance at the cost of additional latency. However, due to the multi-rate processing techniques, the processing circuit 308 is no longer as sensitive to the added latency. Example implementations of the processing paths 312-1 to 312-N are further described with respect to FIGS. 8 to 10.

FIG. 8 illustrates an example implementation of a processing circuit 308 that includes at least three processing paths 312-(K−1), 312-K, and 312-(K+1), where K represents a positive integer. In this example, the processing paths 312-(K−1) to 312-(K+1) are coupled together in tiers (e.g., layers or stages) instead of being coupled together in parallel. As such, the processing path 312-K is coupled between the processing paths 312-(K−1) and 312-(K+1).

The processing paths 312-(K−1), 312-K, and 312-(K+1) are respectively associated with processing rates 314-(K−1), 314-K, and 314-(K+1). The processing rate 314-(K−1) is faster than the processing rate 314-K, which is faster than the processing rate 314-(K+1). The processing rates 314-(K−1) to 314-(K+1) can be responsive processing rates 316, power-efficient processing rates 318, or some combination thereof. Consider an example in which the processing circuit 308 includes three processing paths 312. In this case, the processing rate 314-(K−1) can be a responsive processing rate 316, and the processing rate 314-(K+1) can be a power-efficient processing rate 318. The processing rate 314-K can be a responsive processing rate 316 or a power-efficient processing rate 318.

In the depicted configuration, the processing path 312-K includes the tunable filter 702, the decimator 704, the interpolator 706, and the combiner 710. The processing path 312-K also optionally includes the phase-correction circuit 708. Although not explicitly shown, the tunable filter 702 and the phase-correction circuit 708 can be coupled to the control circuit 310.

The processing paths 312-(K−1) and 312-(K+1) may include some or all of the components of the processing path 312-K. In an example implementation, the processing path 312-(K−1) at least includes a tunable filter 702 and a combiner 710, and the processing path 312-(K+1) at least includes a decimator 704, a tunable filter 702, and an interpolator 706.

An input of the decimator 704 is coupled to the processing path 312-(K−1), and an output of the decimator 704 is coupled to the phase-correction circuit 708. Although not explicitly shown, the input of the decimator 704 can be coupled to an input, a decimator 704, or a phase-correction circuit 708 of the processing path 312-(K−1). The phase-correction circuit 708 has an output that is coupled to the tunable filter 702 and the processing path 312-(K+1). The output of the phase-correction circuit 708 can be coupled to the decimator 704 of the processing path 312-(K+1) (not shown in FIG. 8). Other implementations are also possible in which the phase-correction circuit 708 is integrated within the tunable filter 702 or is implemented between the tunable filter 702 and the combiner 710.

In FIG. 8, the tunable filter 702 is coupled between the phase-correction circuit 708 and the combiner 710. The combiner 710 has inputs coupled to the tunable filter 702 and the processing path 312-(K+1). One of the inputs of the combiner 710 can be coupled to an interpolator 706 of the processing path 312-(K+1) (not shown in FIG. 8). The interpolator 706 is coupled between the combiner 710 and the processing path 312-(K−1). Although not explicitly shown, the output of the interpolator 706 can be coupled to a combiner 710 of the processing path 312-(K−1).

During operation of the active-noise-cancellation circuitry 112, the tunable filter 702 accepts a first control signal 802 from the control circuit 310. The control signal 802 can specify filter coefficients 824 of the tunable filter 702, which were previously determined based on a calibration process or measured during operation. Also, the phase-correction circuit 708 can accept a second control signal 804 from the control circuit 310. The second control signal 804 can adjust or set a delay 826 that is applied by the phase-correction circuit 708 to align an output of the processing path 312-K with another one of the processing paths 312-(K−1) and/or 312-(K+1) for active noise cancellation 114.

During active noise cancellation 114, the processing path 312-K accepts an input signal 806, which has an input sampling rate 808 (input SR 808). In this case, the processing path 312-(K−1) provides the input signal 806 to the processing path 312-K. In a first example, the input signal 806 is the digital noise reference signal 612, and the input sampling rate 808 is the base sampling rate 606. In a second example, the input signal 806 is a decimated version of the digital noise reference signal 612, and the input sampling rate 808 is the processing rate 314-(K−1).

The decimator 704 of the processing path 312-K generates a decimated signal 810 based on the input signal 806 and the downsampling integer factor 720. The decimated signal 810 has a sampling rate 812 (SR 812) that is equal to the input sampling rate 808 divided by the downsampling integer factor 720. In this case, the downsampling integer factor 720 is set such that the sampling rate 812 is equal to the processing rate 314-K of the processing path 312-K.

The phase-correction circuit 708 adjusts a phase of the decimated signal 810 based on the second control signal 804 and generates a phase-corrected signal 814. The phase-corrected signal 814 is provided to the processing path 312-(K+1) for further processing. The tunable filter 702 filters the phase-corrected signal 814 based on the filter coefficients 824 provided by the first control signal 802 and generates the filtered signal 816.

The combiner 710 accepts the filtered signal 816 from the tunable filter 702 and accepts anti-noise component signal 614-(K+1) from the processing path 312-(K+1). The filtered signal 816 and the anti-noise component signal 614-(K+1) have the sampling rate 812. The combiner 710 generates a composite signal 818, which represents a combination (e.g., a summation) of the filtered signal 816 and the anti-noise component signal 614-(K+1). In some implementations, the processing path 312-(K+1) may include further audio processing and other audio signals such as ambient inclusion, audio scene customization and inclusion of external audio such as received signals from a wireless interface such as Bluetooth™.

The interpolator 706 generates anti-noise component signal 614-K based on the composite signal 818 and the upsampling integer factor 726. The anti-noise component signal 614-K represents an output signal 820 that is generated by the processing path 312-K. The output signal 820 has an output sampling rate 822 (output SR 822) that is equal to the sampling rate 812 multiplied by the upsampling integer factor 726. In this example, the downsampling integer factor 720 is equal to the upsampling integer factor 726. As such, the input sampling rate 808 is equal to the output sampling rate 822. Other example implementations of the processing circuit 308 are further described with respect to FIGS. 9 and 10.

FIG. 9 illustrates an example implementation of the processing circuit 308 with two processing paths 312-1 and 312-2. In this example, the processing paths 312-1 and 312-2 are implemented in parallel between the microphone 306 (or the analog-to-digital converter 604) and the combiner 602. The processing path 312-1 is associated with the processing rate 314-1, which represents a responsive processing rate 316. The processing path 312-2 is associated with the processing rate 314-2, which represents a power-efficient processing rate 318.

The processing path 312-1 includes a tunable filter 702-1. The processing path 312-1 does not include a decimator 704 and does not include an interpolator 706. As such, the processing rate 314-1 is equal to the base sampling rate 606. The processing path 312-2 includes the decimator 704, the tunable filter 702-2, and the interpolator 706. Although not explicitly shown, the processing path 312-2 can also include the phase-correction circuit 708. The phase-correction circuit 708 can be coupled between the decimator 704 and the tunable filter 702-2, coupled between the tunable filter 702-2 and the interpolator 706, or implemented within the tunable filter 702-2.

During operation of the hearable 102, the tunable filters 702-1 and 702-2 respectively accept first control signals 802-1 and 802-2 from the control circuit 310. The control signals 802-1 and 802-2 respectively specify filter coefficients 824 of the tunable filters 702-1 and 702-2. These filter coefficients 824 can be determined as part of the calibration process described at FIG. 11 and adjusted during operation of the hearable 102.

During active noise cancellation 114, the processing paths 312-1 and 312-2 accept the digital noise reference signal 612, which has the base sampling rate 606 (BSR 606). The tunable filter 702-1 of the processing path 312-1 generates a filtered signal 816-1 based on the digital noise reference signal 612 and the filter coefficients 824 provided by the control signal 802-1. The filtered signal 816-1 also represents the anti-noise signal component 614-1 generated by the processing path 312-1.

The decimator 704 of the processing path 312-2 generates the decimated signal 810 based on the downsampling integer factor 720. The decimated signal 810 has the sampling rate 812, which is equal to the processing rate 314-2. The tunable filter 702-2 generates the filtered signal 816-2 based on the decimated signal 810 and the filter coefficients 824 provided by the control signal 802-1. The interpolator 706 generates the anti-noise signal component 614-2 based on the upsampling integer factor 726. The anti-noise signal component 614-2 has a sampling rate that is equal to the base sampling rate 606.

The combiner 602 combines the anti-noise signal components 614-1 and 614-2 together to generate the anti-noise signal 516. By combining anti-noise signal components 614-1 and 614-2 from processing paths 312-1 and 312-2 associated with different processing rates 314, the processing circuit 308 can perform activate noise cancellation 114 with a target level of responsiveness and power efficiency. Another example implementation of the processing circuit 308 is further described with respect to FIG. 10.

FIG. 10 illustrates an example implementation of the processing circuit 308 having more than two processing paths 312-1 to 312-N. In the depicted configuration, the processing paths 312-1 to 312-N are implemented in tiers (e.g., stages or layers) instead of being implemented in parallel (as shown in FIG. 9). As such, the decimators 704-1 to 704-N are coupled together to form a chain (or path) of decimators 704, and the interpolators 706-1 to 706-N are coupled together to form a chain (or path) of interpolators 706. In effect, the processing rate 314 associated with one of the processing paths 312-2 to 312-N is realized by the decimation performed by that processing path 312 and all the processing paths 312 preceding it (e.g., by the processing paths 312 that are “above” the particular processing path 312 in this tiered architecture). In this manner, the decimation and interpolation are performed in stages, which enables the decimators 704-2 to 704-N and the interpolators 701-2 to 706-N to consume less power compared to implementations in which the processing paths 312-1 to 312-N are implemented in parallel.

In this example, the processing path 312-1 is associated with the processing rate 314-1, which represents a responsive processing rate 316. The processing paths 312-2 to 312-N are respectively associated with the processing rates 314-2 to 312-N, which represent power-efficient processing rates 318-1 to 318-(N-1).

The processing path 312-1 includes the tunable filter 702-1 and the combiner 710-1. The processing path 312-1 can also optionally include the decimator 704-1 and the interpolator 706-1. The processing paths 312-2 and 312-N respectively include decimators 704-2 and 704-N, tunable filters 702-2 and 702-N, and interpolators 706-2 and 706-N. The processing path 312-2 also includes a combiner 710-2. Since the processing path 312-N represents a “last” processing path 312 in the tiered structure (e.g., the processing path 312-N is at the lowest tier), the processing path 312-N does not include a combiner 710 (e.g., a reference noise combiner), but could combine a noise reference with audio playback, e.g. from a wireless Bluetooth™ connection. An operation of the processing paths 312-1 to 312-N can be similar to the operations described above with respect to FIGS. 8 and 9. To determine the filter coefficients 824 provided by the control signals 802-1, 802-2, and 802-N, the active-noise-cancellation circuitry 112 can perform a calibration process, which is further described with respect to FIG. 11. In some implementations, the calibration process may continue even after the unit has started noise reduction operations.

FIG. 11 illustrates an example flow diagram 1100 for performing a calibration process to configure active-noise-cancellation circuitry 112 for multi-rate processing. A transfer function of the active-noise-cancellation circuitry 112 represents a combined transfer function of the processing paths 312, which perform filtering at multiple processing rates 314. Due to the multiple processing rates 314, it can be challenging using analytical techniques to determine optimal parameters of the processing paths 312.

To address this challenge, a calibration process determines the optimal parameters (e.g., filter coefficients 824) by performing an iterative impulse-based approach that fits an impulse response associated with each processing path 312 to at least a portion of a target impulse response or a difference between the target impulse response and the fitted impulse response(s) of one or more other processing path(s) 312. In this way, the parameters can be determined such that the impulse response 414 of the processing circuit 308 approximates the target impulse response 402. This calibration process can be used to determine the filter coefficients 824 of the tunable filters 702 within the processing paths 312 independent of whether the tunable filters 702 are implemented as finite-impulse-response filters 712, infinite-impulse-response filters 714, or some combination thereof. The calibration process can also be used to determine the delay(s) 826 of the phase-correction circuit(s) 708 within the processing circuit 308.

At 1102, a first fitted impulse response of multiple fitted impulse responses is generated by fitting, for a first processing path of multiple processing paths associated with different processing rates, an impulse response of the first processing path to at least a first portion of a target impulse response. For example, the calibration process generates a first fitted impulse response by fitting a first impulse response of the first processing path 312-1 to at least the portion 416-1 of the target impulse response 402. The first processing path 312-1 can represent the processing path 312-(K−1) in FIG. 8, the processing path 312-1 in FIG. 9, or the processing path 312-1 in FIG. 10. In this case, the first processing path 312-1 is associated with the first processing rate 314-1, which is a responsive processing rate 316. In some implementations, the first processing path 312-1 is associated with a fastest processing rate 314 of the multiple processing rates 314.

Before fitting the first impulse response to the target impulse response 404, a windowing function (e.g., a taper) can be applied to the target impulse response 404 to enable the first fitted impulse response to be fitted to the portion 416-1 of the target impulse response 402. The windowing function can be slightly longer than the portion 416-1 to facilitate a smooth transition between the portions 416-1 and 416-2 of the impulse response 414.

The target impulse response 402 can be predetermined to enable the active-noise-cancellation circuitry 112 to attenuate the noise as obtained by noise reference signal 514 by a particular amount. In some cases, the target impulse response 402 can be associated with different structures of the ear canal 110, different fits of the hearable 102 within or over the ear 108, or different noise environments.

At 1104, at least one other fitted impulse response of the multiple fitted impulse responses is generated by fitting, for each remaining processing path of the multiple processing paths, an impulse response of a selected processing path to at least a second portion of a difference between the target impulse response and one or more previously-generated fitted impulse responses. For example, the calibration process generates at least one other fitted impulse response by fitting an impulse response of the second processing path 312-2 to at least a second portion of a difference between the target impulse response 402 and the first fitted impulse response. The second portion can include the portion 416-1, the portion 416-2, or both portion 416-1 and 416-2. If the second processing path 312-2 is associated with the responsive processing rate 316, the second portion can represent the portion 416-1. Alternatively, if the second processing path 312-2 is associated with the power-efficient processing rate 318, the second portion can represent the portion 416-2 or both the portions 416-1 and 416-2.

The second processing path 312-2 is associated with the second processing rate 314-2, which can be a power-efficient processing rate 318 in some examples. If the processing circuit 308 includes two processing paths 312, the second processing path 312-2 is associated with a slowest processing rate 314 of the multiple processing rates 314. The second processing path 312-2 can represent the processing path 312-K in FIG. 8, the processing path 312-2 in FIG. 9, or the processing path 312-2 in FIG. 10.

If the processing circuit 308 includes more than two processing paths 312, this process can continue for the other processing paths (e.g., for a third processing path or for an Nth processing path 312-N). In some implementations, the generating of the other fitted impulse responses is performed based on an order in which the selected processing paths have slower processing rates 314. In other words, each remaining processing path 312 is selected such that a currently selected processing path has a slower processing rate 314 than a previously-selected processing path.

At 1106, at least the first fitted impulse response is regenerated by fitting the impulse response of the first processing path to at least the first portion of the difference between the target impulse response and the at least one other fitted impulse response. For example, the calibration process regenerates the first fitted impulse response by fitting the impulse response of the first processing path 312-1 to the portion 416-1 of the difference between the target impulse response 404 and the second fitted impulse response (or a combination of the other fitted impulse responses if there are more than two other fitted impulse responses). The process described at 1106 represents a post-processing correction stage in which at least the first fitted impulse response is regenerated. Other ones of the fitted impulse responses (e.g., the second fitted impulse response) can also be regenerated to further enable the impulse response 414 to approximate the target impulse response 402. Generally speaking, any fitting technique can be used at 1102 to 1106. In an example implementation, the Steiglitz-McBride algorithm may be used to perform the fitting at least at 1104 when employing an infinite-impulse-response filter. When using finite-impulse-response filters (using data associated with the pulse-density-modulation domain 322 or the pulse-code-modulation domain 324), the desired impulse response can be used as the coefficients of the filters, thereby yielding the desired waveform.

At 1108, parameters of the multiple processing paths are determined based on the multiple fitted impulse responses. For example, the calibration process determines parameters of the processing paths 312-1 to 312-N based on the multiple fitted impulse responses. More specifically, the calibration process determines parameters of the first processing path 312-1 based on the first fitted impulse response and determines parameters of the second processing path 312-2 based on the second fitted impulse response. The parameters at least include filter coefficients 824 associated with the tunable filters 702 within the processing paths 312. Optionally, the parameters can also include a delay 826 associated with the phase-correction circuit 708 within at least one of the processing paths 312. In some implementations, the phase-correction circuit 708 may include the option of providing fractional delays. In other implementations, it may include adjusting the phase so that any phase distortion from the interpolator or decimator paths are countered to provide a flat phase response. In other implementations, the phase-correction circuit 708 may be merged with the decimator 704 or interpolator 706 to provide for fractional delay compensation without significantly increasing the silicon area or power consumption.

In some implementations, the calibration process is performed offline during manufacturing of the active-noise-cancellation circuitry 112. It is also possible to perform the calibration process during an operation of the hearable 102 to dynamically adjust the parameters of the multiple processing paths 312 to a current environment or a particular user 106.

### Multi-Domain Processing for Active Noise Cancellation

FIG. 12 illustrates an example processing circuit 308 that performs multi-domain processing. In the depicted configuration, the processing circuit 308 includes at least the processing paths 312-1 and 312-2. The processing path 312-1 is associated with the processing rate 314-1, which represents a responsive processing rate 316. The processing path 312-2 is associated with the processing rate 314-2, which represents a power-efficient processing rate 318. Although the processing paths 312-1 and 312-2 are shown to be coupled in parallel between a node of the processing circuit 308 and the combiner 602 in FIG. 12, other implementations are also possible in which the processing paths 312-1 and 312-2 are coupled together in a tiered structure, such as the tired structure shown in FIG. 8 or 10.

Although not shown for simplicity, the processing circuit 308 can include additional processing paths 312 (e.g., processing path 312-N), which can include additional decimators, interpolators, or phase-correction circuits. In this case, the one or more additional processing paths 312 that are associated with responsive processing rates 316 can also be associated with the pulse-density-modulation domain 322. In some implementations, a crest factor of the anti-noise signal 516 can be reduced by implementing multiple processing paths 312 associated with the responsive processing rate 316 and the pulse-density-modulation domain 322. Also, the one or more additional processing paths 312 that are associated with the power-efficient processing rates 318 can also be associated with the pulse-code-modulation domain 324.

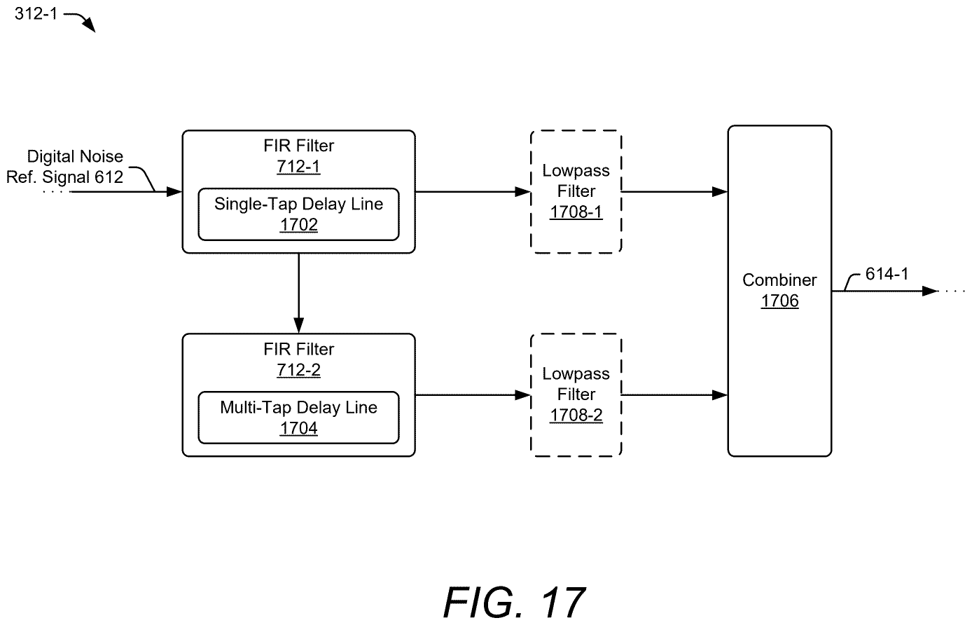

The tunable filter 702-1 of the processing path 312-1 can be implemented using a finite-impulse-response filter 712. The combination of the pulse-density-modulation domain 322 and the finite-impulse-response filter 712 enables multiplication operations within the tunable filter 702-1 to be replaced with addition operations, which reduces power consumption. In some implementations, the finite-impulse-response filter 712 is implemented as a bit-based finite-impulse-response filter 1202, which can further reduce power consumption as described with respect to FIG. 13. In other implementations, the processing path 312-1 utilizes multiple finite-impulse-response filters 712 to reduce the latency and the crest factor, as further described with respect to FIG. 17.

The tunable filter 702-2 of the processing path 312-2 can be implemented using another finite-impulse-response filter 712 or an infinite-impulse-response filter 714. The pulse-code-modulation domain 324 along with the power-efficient processing rate 318 provides additional flexibility in designing the tunable filter 702-2. In some cases, the tunable filter 702-2 can be designed to perform other, sometimes more complicated, operations such as multi-band compression, envelope detection, and/or non-linear filtering. Furthermore, since the tunable filter 702-2 operates at the power-efficient processing rate 318, the tunable filter 702-2 can be designed to realize a higher quality of performance with less strict power-consumption constraints and latency-constraints.

### Bit-Based Finite-Impulse-Response Filtering

FIG. 13 illustrates components of the bit-based finite-impulse-response filter 1202. In the depicted configuration, the bit-based finite-impulse-response filter 1202 includes a delay line 1302, a multiplication circuit 1304, and an integration circuit 1306. The techniques for bit-based finite-impulse-response filtering take advantage of the single-bit input associated with pulse-density-modulation domain 322 to design a power-efficient finite-impulse-response filter 712. To improve power efficiency, the architecture of the bit-based finite-impulse-response filter 1202 simplifies and/or reduces a quantity of computations that are performed. These power-saving techniques can be applied to the delay line 1302, the multiplication circuit 1304, the integration circuit 1306, or some combination thereof.

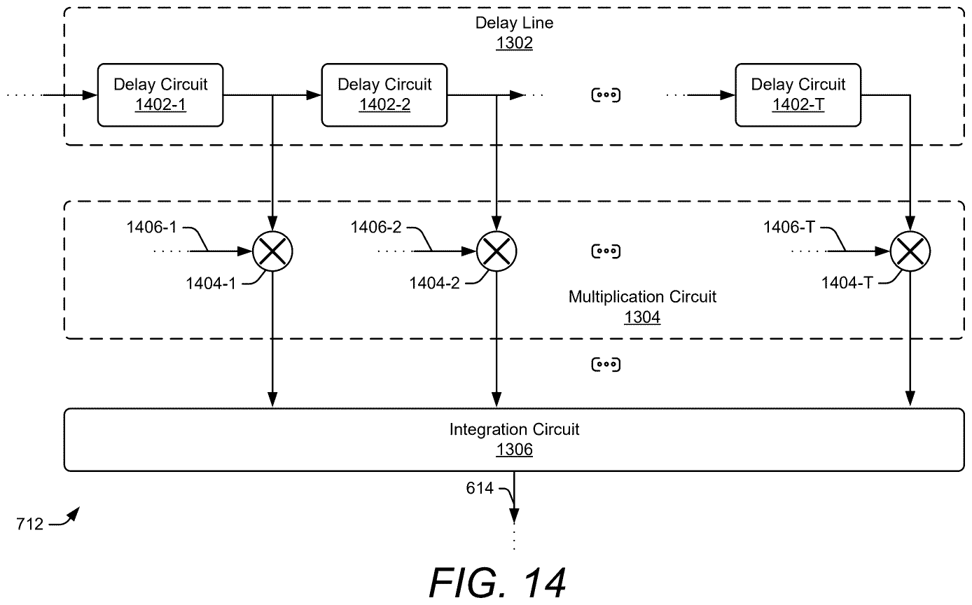

The delay line 1302 enables multiple samples of an incoming signal to be processed. In some implementations, each delay circuit of the delay line 1302 is followed by a tap (or output node), an example of which is illustrated in FIG. 14. To reduce power consumption using bit-based finite-impulse-response filtering, the delay line 1302 can be implemented using a reduced-tap delay line 1308 or a multi-stream delay line 1310. The reduced-tap delay line 1308 reduces the quantity of filter coefficients 824, which in turns reduces the quantity of operations performed by the bit-based finite-impulse-response filter 1202 to improve power efficiency. Limiting the number of coefficients used can cause aliasing of the frequency response onto multiple frequency bands. This may be acceptable in some cases given these bands may be outside the audible range. The multi-stream delay line 1310 splits samples of an input signal into at least two separate streams, which can be clocked at a slower frequency compared to processing the input signal using a single stream. In some implementations, the multi-stream delay line 1310 can be implemented using a serializer and a deserializer.

The multiplication circuit 1304 applies the filter coefficients 824 to samples of the input signal that are provided by the delay line 1302. In some implementations, the multiplication circuit 1304 includes multiple multipliers, an example of which is illustrated in FIG. 14. To reduce power consumption using aspects of bit-based finite-impulse-response filtering, the multiplication circuit 1304 can instead be implemented using a single-tap coefficient-selection circuit 1312 or a multi-tap correlation circuit 1314.

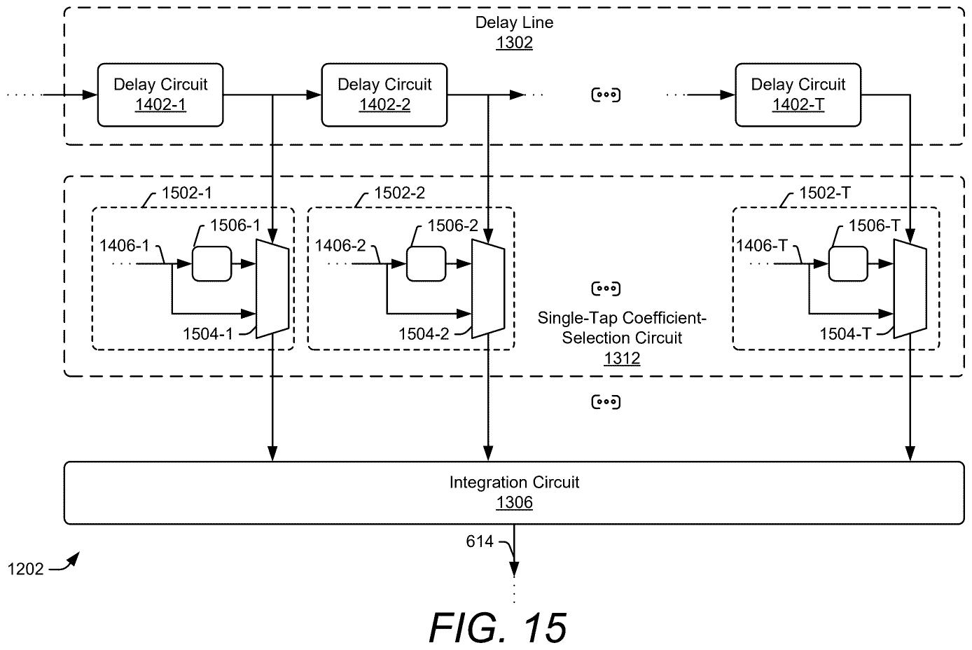

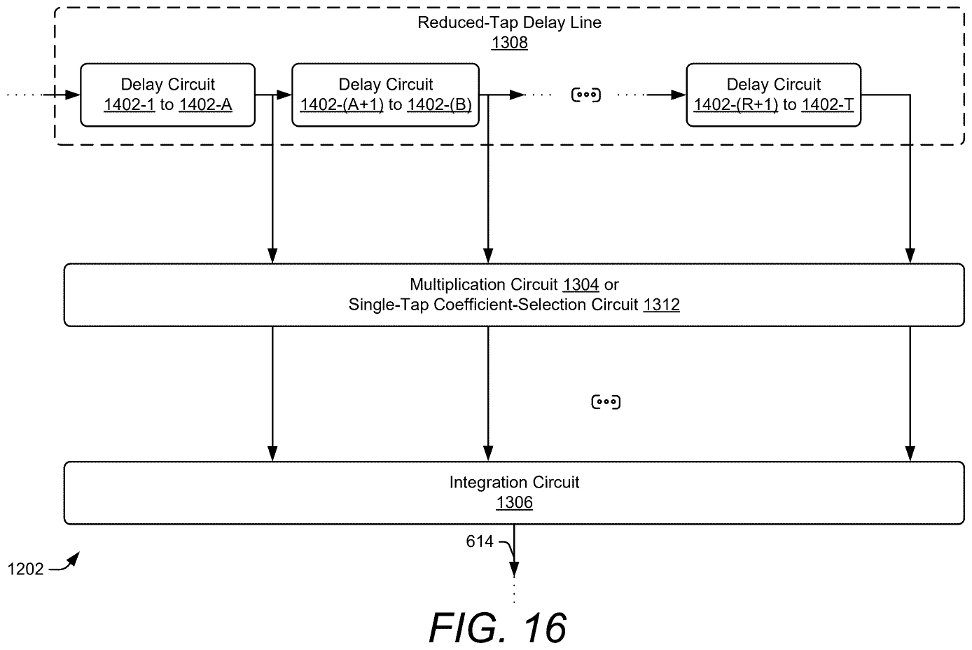

The integration circuit 1306 performs a summation operation across the samples provided by the multiplication circuit 1304 to generate the anti-noise signal component 614. The reason each coefficient multiplication can be replaced with an addition or subtraction is that the input samples consists of a single bit. Therefore the integration circuit 1306 either adds or subtracts a coefficient for each tap value. To reduce power consumption using aspects of bit-based finite-impulse-response filtering, the integration circuit 1306 can be implemented as a multi-level adder tree 1316 or a multi-phase adder tree 1318. Additionally or alternatively, the integration circuit 1306 can include an offset circuit 1320. The offset circuit 1320 treats the input samples as either zero or one and adds twice the coefficient value when the tap value is one. There is no change if the tap value is zero. The offset circuit 1320 can contain minus the sum of all the coefficients. This way, the offset circuit 1320 can replace a subtraction in every stage with a fixed offset. The above aspects of bit-based finite-impulse-response filtering can be applied in a variety of different combinations, as further described with respect to FIGS. 15 and 16. A general architecture of a finite-impulse-response filter 712 is further described with respect to FIG. 14.

FIG. 14 illustrates an example implementation of a finite-impulse-response filter 712, which can be used to implement the tunable filter 702-1 of the processing path 312-1 shown in FIG. 12. The finite-impulse-response filter 712 includes the delay line 1302, the multiplication circuit 1304, and the integration circuit 1306. The delay line 1302 is coupled to the multiplication circuit 1304. The multiplication circuit 1304 is coupled to the integration circuit 1306.

In the depicted configuration, the delay line 1302 includes multiple delay circuits 1402-1, 1402-2 . . . 1402-T, where T represents a positive integer. The multiplication circuit 1304 includes multiple multipliers 1404-1, 1404-2 . . . 1404-T. Each multiplier 1404 has a first input coupled to a corresponding delay circuit 1402, a second input coupled to the control circuit 310 (not shown), and an output coupled to the integration circuit 1306. The multipliers 1404-1 to 1404-T perform respective multiplication operations to apply filter coefficients 1406-1, 1406-2 . . . 1406-T to samples provided by the delay line 1302. To improve power efficiency of the finite-impulse response filter 712, the techniques of bit-based finite-impulse-response filtering can be applied to implement the bit-based finite-impulse-response filter 1202, examples of which are further described with respect to FIGS. 15 and 16.

FIG. 15 illustrates a first example implementation of the bit-based finite-impulse-response filter 1202. The bit-based finite-impulse-response filter 1202 includes the delay line 1302 and the integration circuit 1306, which can be similar to the delay line 1302 and the integration circuit 1306 described with respect to the finite-impulse-response filter 712 of FIG. 14. In this example, however, the bit-based finite-impulse-response filter 1202 includes the single-tap coefficient-selection circuit 1312 instead of the multiplication circuit 1304.

The single-tap coefficient-selection circuit 1312 includes multiple selection circuits 1502-1, 1502-2 . . . 1502-T, which are respectively coupled between corresponding delay circuits 1402-1 to 1402-T and corresponding inputs of the integration circuit 1306. The selection circuits 1502 can provide a similar output as the multipliers 1404 within the multiplication circuit 1304 without performing multiplication operations. By eliminating the multiplication operations associated with the multiplication circuit 1304, the bit-based finite-impulse-response filter 1202 can consume less power than the finite-impulse-response filter 712 of FIG. 14.

In this example, the selection circuits 1502-1 to 1502-T respectively include multiplexers 1504-1, 1504-2 . . . 1504-T and two's complement inverters 1506-1, 1506-2 . . . 1506-T. During active noise cancellation 114, each selection circuit 1502 provides a corresponding filter coefficient 1406 or a two's complement of the filter coefficient 1406 to the integration circuit 1306 based on a value of the sample provided by the corresponding delay circuit 1402. Alternatively, the two's complement inverters 1506 can be replaced with one's complement inverters (i.e. omitting a plus one operation) and the error that is made can be corrected in a separate adder circuit (not shown). In this case, the number of negative coefficients can be counted and added to the final sum found by the integration circuit 1306.

FIG. 16 illustrates a second example implementation of the bit-based finite-impulse-response filter 1202. In the depicted configuration, the bit-based finite-impulse-response filter 1202 includes the integration circuit 1306 and either the multiplication circuit 1304 or the single-tap coefficient selection circuit 1312. Instead of including the delay line 1302 shown in FIGS. 14 and 15, the bit-based finite-impulse-response filter 1202 of FIG. 16 includes the reduced-tap delay line 1308. In this case, the reduced-tap delay line 1308 has fewer taps compared to the delay line 1302 of FIGS. 14 and 15. Reducing the quantity of taps effectively reduces the quantity of filter coefficients 1406, which reduces the cost of performing calculations at the responsive processing rate 316. As an example, a delay line with 1024 delay elements, operating at 3.072 MHz may have taps for every 16^{th} delay cell. Thus, the bit-based FIR filter 1202 can use 64 coefficients and perform 64 calculations instead of 1024. Although this can cause the frequency response below 96 kHz to be mirrored in the upper bands (96-1536 kHz), these bands are inaudible and therefore doesn't negatively impact the user experience.

### Decreasing Latency and Crest Factor for Pulse-Density-Modulation Domain Processing

Use of the pulse-density-modulation domain 322 can inherently increase the crest factor of the composite signal 518 as the samples that pass through the processing path 312-1 associated with the pulse-density-modulation domain 322 pass through with substantially less filtering. This amount of filtering is in comparison to the samples that pass through the one or more processing paths 312 associated with the pulse-code-modulation domain 324 (e.g., the processing path 312-2 in FIG. 12). A larger crest factor can negatively impact the performance of the hearable 102 as the amplifier 504 can have a limited dynamic range. To account for the larger crest factor, some techniques decrease the maximum acoustic level of the anti-noise signal 516. However, this decreases the performance of the hearable 102 for active noise cancellation 114. To address this problem, the processing path 312-1 associated with the pulse-density-modulation domain 322 is implemented using at least one filter that is designed to reduce latency and at least one other filter that is designed to reduce the crest factor, as further described with respect to FIG. 17.

FIG. 17 illustrates an example implementation of the processing path 312-1 associated with the pulse-density-modulation domain 322. In the depicted configuration, the processing path 312-1 includes multiple finite-impulse-response filters 712-1 and 712-2. The finite-impulse-response filter 712-1 is implemented using a single-tap delay line 1702 and is designed to reduce the latency associated with the pulse-density-modulation domain 322 processing. In contrast, the finite-impulse-response filter 712-2 is implemented using a multi-tap delay line 1704 and is designed to reduce the crest factor associated with the pulse-density-modulation domain 322 processing.

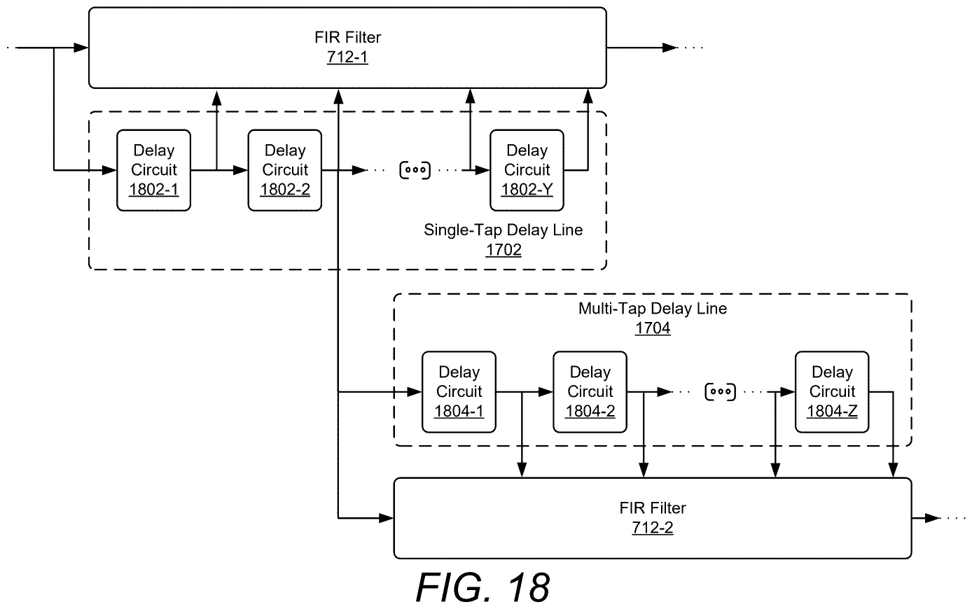

In general, the single-tap delay line 1702 and the multi-tap delay line 1704 include multiple delay circuits. For the single-tap delay line 1702, each delay circuit delays an input signal by one sampling period. In contrast, each delay circuit in the multi-tap delay line 1704 can delay an input signal by multiple sampling periods. Example implementations of the single-tap delay line 1702 and the multi-tap delay line 1704 are further described with respect to FIG. 18. Use of the single-tap delay line 1702 and the multi-tap delay line 1704 enable an initial part of an input signal to be sampled with a greater density compared to a later part of the input signal. With a greater density of samples, the correlation between the samples can increase, which can reduce variability in an output of the finite-impulse-response filter 712-1 and reduce the latency. It also allows the finite-impulse-response filter 712-2 to be implemented as a steeper and slower filter to reduce the crest factor.

The finite-impulse-response filters 712-1 and 712-2 can be coupled to a combiner 1706, which generates the anti-noise signal component 614-1 of the processing path 312-1. Optionally, one or more low-pass filters can be coupled between the finite-impulse-response filters 712-1 and 712-2 and the combiner 1706. In an example implementation, a first low-pass filter 1708-1 is coupled between the finite-impulse-response filter 712-1 and the combiner 1706. Additionally or alternatively, a second low-pass filter 1708-2 is coupled between the finite-impulse-response filter 712-2 and the combiner 1706.

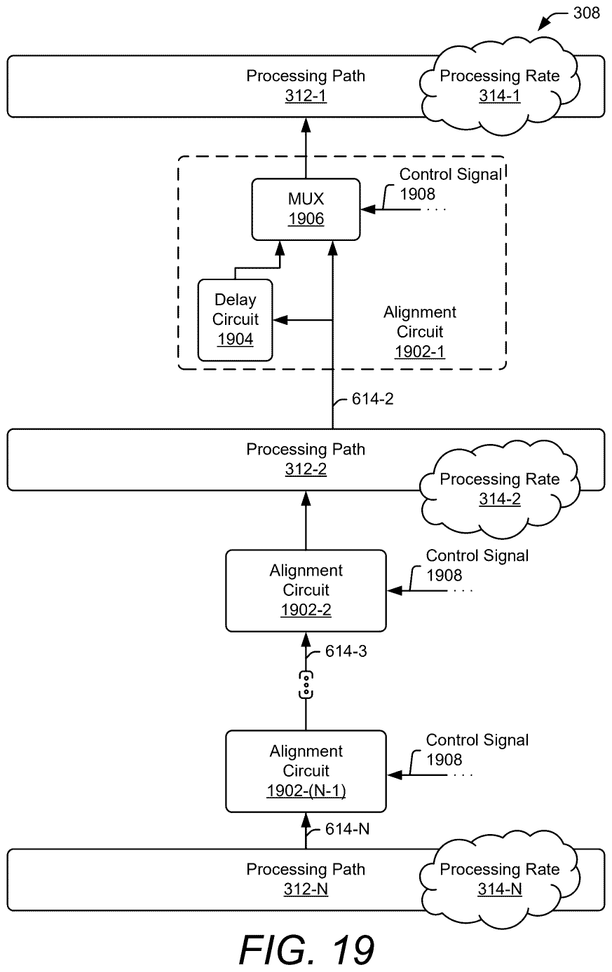

In an example implementation, the finite-impulse-response filter 712-1 applies no filtering or very little filtering to the input stream. The finite-impulse-response filter 712-1 can be implemented using filter coefficients {1, 1}, which creates a pole at half the sampling rate of the input signal. Another implementation extends this scheme by the use of Pascal's triangle. In particular, the finite-impulse-response filter 712-1 uses example coefficients such as {1, 2, 1} or {1, 3, 3, 1} for creating multiple poles at half the sampling rate of the input signal. This exploits the strong correlation between samples for noise reduction. A delay associated with the finite-impulse-response filter 712-1 can be on the order of half a sample (e.g., a delay equal to approximately half a sample, one sample, or one and a half samples). Although not explicitly shown in FIG. 17, the processing path 312-1 can include one or more delay cells (or alignment circuits as shown in FIG. 19) to align the outputs of the finite-impulse-response filters 712-1 and 712-2 at the combiner 1706.

The finite-impulse-response filter 712-2 can be coupled to an intermediate node of the single-tap delay line 1702, as shown in FIG. 18. This can ensure the outputs of the finite-impulse-response filters 712-1 and 712-2 are phase aligned (e.g., ensure the group delay of the slightly slower finite-impulse-response filter 712-2 matches up with the samples from the faster finite-impulse-response filter 712-1).

Additional amplitude scaling can be applied so that the amplitude of the anti-noise signal component 614-1 is not substantially impacted by the use of two finite-impulse-response filters 712-1 and 712-2. For example, if the finite-impulse-response filter 712-1 processes samples at a density that is four times greater than the density of samples processed by the finite-impulse-response filter 712-2, an output of the finite-impulse-response filter 712-1 can be weighted by one-fourth of the weighting applied to the output of the finite-impulse-response filter 712-2. The single-tap delay line 1702 and the multi-tap delay line 1704 are further described with respect to FIG. 18.

FIG. 18 illustrates example implementations of the single-tap delay line 1702 and the multi-tap delay line 1704. In the depicted configuration, the single-tap delay line 1702 includes multiple delay circuits 1802-1, 1802-2 . . . 1802-Y, where Y represents a positive integer. The multi-tap delay line 1704 also includes multiple delay circuits 1804-1, 1804-2 . . . 1804-Z, where Z represents a positive integer. The delay circuits 1802-1 to 1802-Y can each delay an input signal by one sampling period. In contrast, the delay circuits 1804-1 to 1804-Z can each delay an input signal by multiple sampling periods (e.g., by 8, 16, or 32 sampling periods). Outputs of the delay circuits 1802-2 to 1802-Y are coupled to other components within the finite-impulse-response filter 712-1. Likewise, outputs of the delay circuits 1804-1 to 1804-Z are coupled to other components within the finite-impulse-response filter 712-2.

In the example shown in FIG. 18, the multi-tap delay line 1704 and the finite-impulse-response filter 712-2 have inputs coupled to an intermediate node within the single-tap delay line 1702. In this case, the intermediate node represents an output node of the delay circuit 1802-2. However, other implementations are also possible in which the intermediate node represents an output of another one of the delay circuits 1802-1 to 1802-Y. This coupling ensures the outputs of the finite-impulse-response filters 712-1 and 712-2 are phase aligned.

### Multi-Path Alignment

FIG. 19 illustrates an example implementation of the processing circuit 308 including multiple alignment circuits 1902-1, 1902-2 . . . 1902-(N-1). The alignment circuits 1902-1 to 1902-(N-1) can selectively apply integer or fractional delays between the processing paths 312-1 to 312-N. With these delays, the alignment circuits 1902-1 to 1902-(N-1) can enable the samples provided by each of the processing paths 312-1 to 312-N to align in phase. In this example, the alignment circuits 1902-1 to 1902-(N-1) are applied between the interpolator stages of the processing paths 312-1 to 312-N. Other implementations are also possible in which the alignment circuits 1902-1 to 1902-(N-1) are coupled between the decimator stages of the processing paths 312-1 to 312-N, similar to the phase-correction circuit 708 shown in FIG. 8.

Each alignment circuit 1902 includes at least one delay circuit 1904 and at least one multiplexer 1906 (MUX 1906). The delay circuit 1904 can delay an input signal by one sampling period. The multiplexer 1906 can select the delayed signal or the non-delayed signal (e.g., the anti-noise signal component 614 of a lower-level processing path 312) and pass the selected signal to a higher-level processing path 312. The control signal 1908 enables fine tuning of the delay applied between the processing paths 312 to realize the desired alignment between the processing paths 312. Use of the multiple alignment circuits 1902 can save on area and power compared to other example implementations of a fractional delay, such as using a dedicated delay line. This effectively replaces a 2^{N}-1 sample first-in first-out (FIFO) queue with N-1 registers.

### Ultrasound Compatibility

Some hearables 102 can transmit ultrasound signals using the speaker 328 and can receive ultrasound signals using the active-noise-cancellation circuitry 112. With the ultrasound signals, the hearables 102 can provide features such as biometric monitoring, on-head detection, speech recognition, bruxism detection, sleep detection and/or classification, howling prevention, and so forth. While it may be desirable to reuse the active-noise-cancellation circuitry 112 to receive and process the ultrasound signals, the existence of the ultrasound signal can impact an operation of the active-noise-cancellation circuitry 112. In some instances, an amplitude of a received ultrasound signal can decrease the dynamic range of the active noise cancellation 114 and/or can cause distortion and/or clipping.

Some techniques address this by applying a wideband band-stop filter to attenuate the ultrasound signal. This filter, however, can significantly increase the latency of the active noise cancellation 114 on the order of tens of microseconds (e.g., by at least 10, 20, or 40 microseconds).

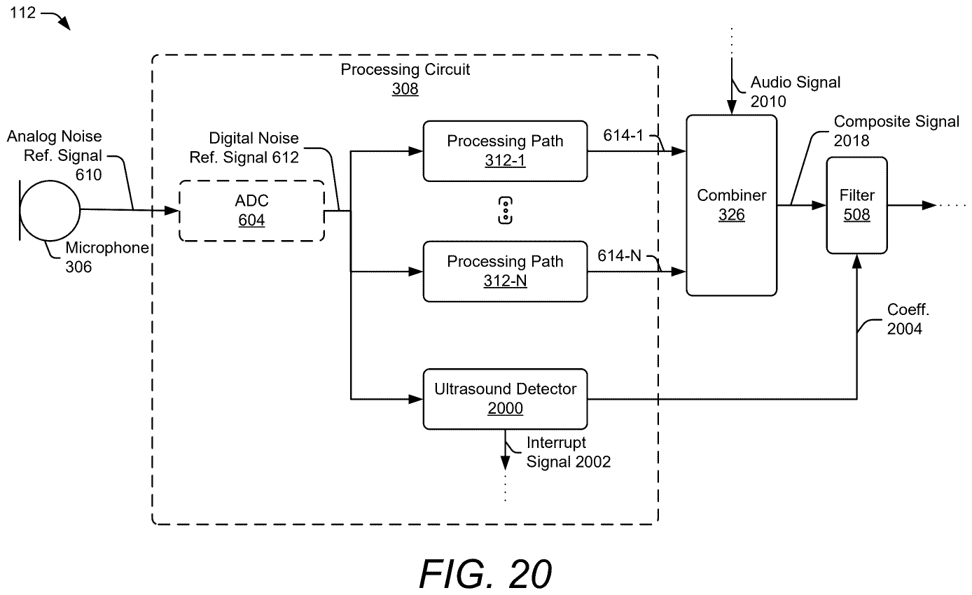

FIG. 20 illustrates an example implementation of the processing circuit 308 that enables ultrasound signals to be processed. In the depicted configuration, the processing circuit 308 includes an ultrasound detector 2000. The ultrasound detector 2000 monitors for any high-level ultrasound signals in the frequency range of approximately 20 to 48 kHz. If the ultrasound detector 2000 detects an ultrasound signal having a sufficiently high amplitude, the ultrasound detector 2000 generates an interrupt signal 2002. The interrupt signal 2002 informs the processing circuit 308 of the presence of the ultrasound signal.

The ultrasound detector 2000 also determines a frequency associated with the ultrasound signal, such as 25 kHz. Based on this frequency, the ultrasound detector 2000 generates filter coefficients 2004 (Coeff. 2004) for the filter 508. In an example implementation, the filter 508 is implemented as an infinite-impulse-response filter with a notch filter response (e.g., a second order notch filter response). In this example, the filter 508 has a notch approximately at the frequency of the ultrasound signal. Also, the filter coefficients applied by the processing paths 312-1 to 312-N can be slowly adapted to attenuate the ultrasound signal.

By filtering for a specific ultrasound frequency instead of a wide band of ultrasound frequencies, the latency of the active-noise-cancellation circuitry 112 can avoid significant delays. The delay associated with the technique described in FIG. 20 can be on the order of a microsecond (e.g., approximately one or two microseconds). Thus, the filtering is customized to the particular audio scene without significantly increasing the latency even if there is ultrasound content present in the received signals.

### Example Methods

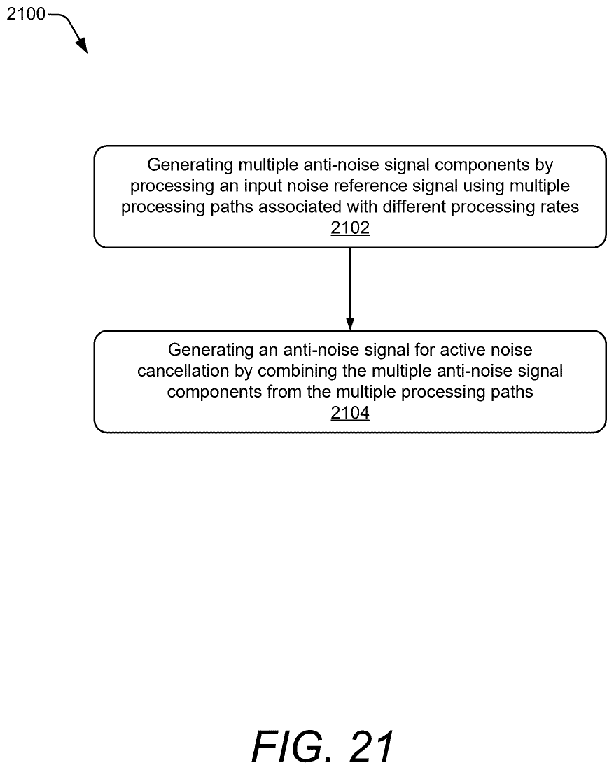

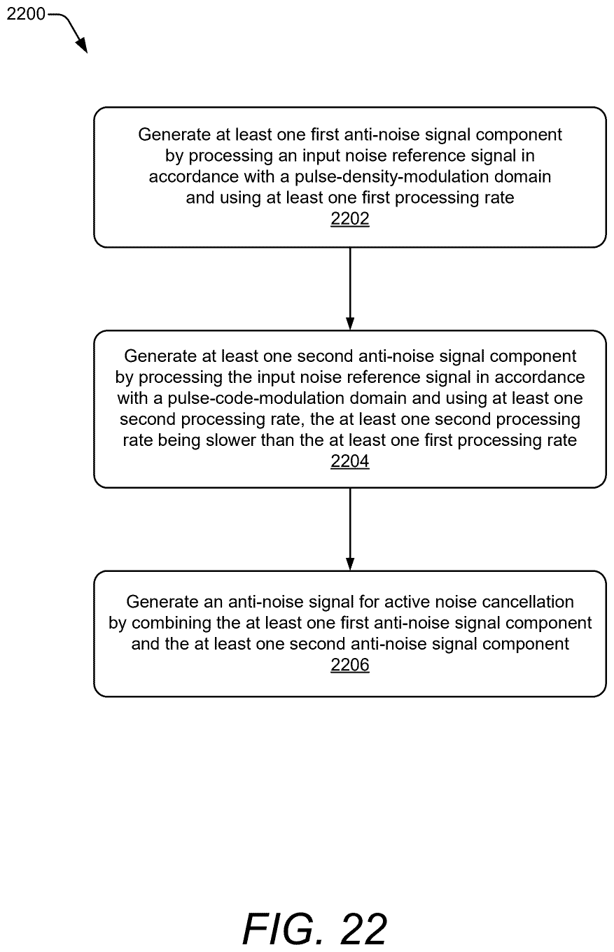

FIGS. 21 and 22 depict example methods 2100 and 2200 for performing multi-rate processing and multi-domain processing, respectively. Methods 2100 and 2200 are shown as a set of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environment 100 of FIG. 1, and entities detailed in FIGS. 2 and 3, reference to which is made for example only. The techniques are not limited to performance by one entity or multiple entities operating on one device.

At 2102, multiple anti-noise signal components are generated by processing an input noise reference signal using multiple processing paths associated with different processing rates. For example, the active-noise-cancellation circuitry 112 generates anti-noise signal components 614-1 to 614-N by processing (e.g., filtering) a digital noise reference signal 612 using multiple processing paths 312-1 to 312-N associated with different processing rates 314-1 to 314-N, as shown in FIGS. 6 and 12. At least one of the processing rates 314-1 to 314-N is a responsive processing rate 316, and at least another one of the processing rates 314-1 to 314-N is a power-efficient processing rate 318. In some implementations, the processing path 312 associated with the responsive processing rate 316 is also associated with the pulse-density-modulation domain 322, and the processing path 312 associated with the power-efficient processing rate 318 is also associated with the pulse-code-modulation domain 324.

The different processing rates 314 represent different sampling rates of the digital noise reference signal 612. The processing paths 312 process (e.g., filter) different versions of the digital noise reference signal 612 corresponding to the different sampling rates. In this manner, the multiple processing paths 312 are associated with different processing rates 314.

At 2104, an anti-noise signal for active noise cancellation is generated by combining the multiple anti-noise signal components from the multiple processing paths. For example, the combiner 602 generates the anti-noise signal 516 by combining the anti-noise signal components 614-1 to 614-N generated by the multiple processing paths, as shown in FIGS. 6 and 12. In an example implementation, the combiner 602 represents a summation circuit, which generates the anti-noise signal 516 based on a summation of the first anti-noise signal component 614-1 with the second anti-noise signal component 614-2. In general, any type of combinational logic can be used to generate the anti-noise signal 516 based on a combination of the first anti-noise signal component 614-1 and the second anti-noise signal component 614-2. The generated anti-noise signal 516 can be used for active noise cancellation 114, as described with respect to FIGS. 1 and 5.

At 2202, at least one first anti-noise signal component is generated by processing an input noise reference signal in accordance with a pulse-density-modulation domain and using at least one first processing rate. For example, the active-noise-cancellation circuitry 112 generates the first anti-noise signal component 614-1 using the first processing path 312-1. The first processing path 312-1 processes the digital noise reference signal 612 in accordance with the pulse-density-modulation domain 322 and uses the first processing rate 314-1, as shown in FIG. 12. This means that the first processing path 312-1 generates the first anti-noise signal component 614-1 by filtering the digital noise reference signal 612 on an individual bit value basis at the first processing rate 314-1. The processing of the digital noise reference signal 612 in accordance with the pulse-density-modulation domain 322 can alternatively be worded as processing the digital noise reference signal 612 based on or using a pulse-density modulation.

At 2204, at least one second anti-noise signal component is generated by processing the input noise reference signal in accordance with a pulse-code-modulation domain and using at least one second processing rate. The at least one second processing rate being slower than the at least one first processing rate. For example, the active-noise-cancellation circuitry 112 generates the second anti-noise signal component 614-2 using the second processing path 312-2. The second processing path 312-2 processes the digital noise reference signal 612 in accordance with the pulse-code-modulation domain 324 and uses the second processing rate 314-2, as shown in FIG. 12. This means that the second processing path 312-2 generates the second anti-noise signal component 614-2 by filtering the digital noise reference signal 612 on a multi-bit value basis at the second processing rate 314-2. The processing of the digital noise reference signal 612 in accordance with the pulse-code-modulation domain 324 can alternatively be worded as processing the digital noise reference signal 612 based on or using a pulse-code modulation. The second processing rate 314-2 is slower than the first processing rate 314-1. In example implementations, the first processing rate 314-1 represents a responsive processing rate 316, and the second processing rate 314-2 represents a power-efficient processing rate 318.

The example processing circuit 308 depicted in FIG. 12 includes one processing path 312-1 associated with the pulse-density-modulation domain 322 and another processing path 312-2 associated with the pulse-code-modulation domain 324. Other implementations are also possible in which the processing circuit 308 includes multiple processing paths associated with the pulse-density-modulation domain 322 (e.g., at least two first processing paths), multiple processing paths associated with the pulse-code-modulation domain 322 (e.g., at least two second processing paths), or some combination thereof.

At 2206, an anti-noise signal for active noise cancellation is generated by combining the at least one first anti-noise signal component and the at least one second anti-noise signal component. For example, the combiner 602 generates the anti-noise signal 516 by combining the anti-noise signal components 614-1 to 614-N generated by the multiple processing paths, as shown in FIGS. 6 and 12. In an example implementation, the combiner 602 represents a summation circuit, which generates the anti-noise signal 516 based on a summation of the first anti-noise signal component 614-1 with the second anti-noise signal component 614-2. In general, any type of combinational logic can be used to generate the anti-noise signal 516 based on a combination of the first anti-noise signal component 614-1 and the second anti-noise signal component 614-2. The generated anti-noise signal 516 can be used for active noise cancellation 114, as described with respect to FIGS. 1 and 5.

### Example Computing System

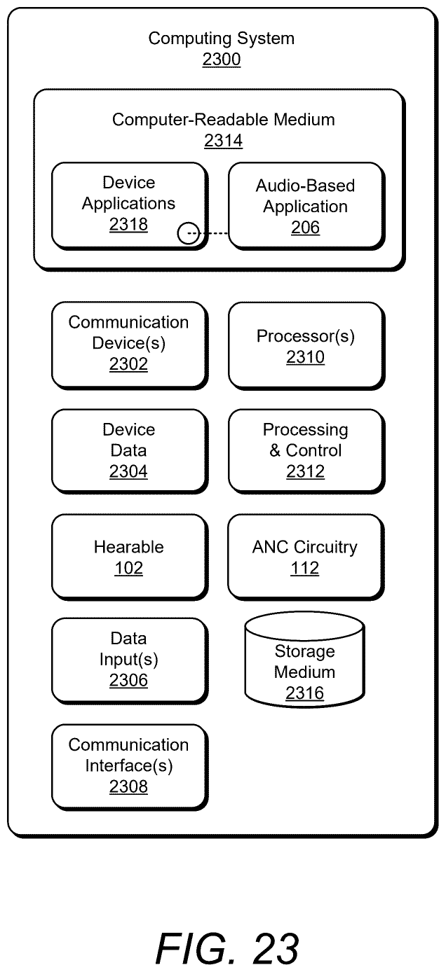

FIG. 23 illustrates various components of an example computing system 2300 that can be implemented as any type of client, server, and/or computing device as described with reference to the previous FIGS. 2 and 3 to implement aspects of multi-rate processing, multi-domain processing, and/or bit-based finite-impulse-response filtering.

The computing system 2300 includes communication devices 2302 that enable wired and/or wireless communication of device data 2304 (e.g., acoustic content). The communication devices 2302 or the computing system 2300 can include one or more hearables 102. The device data 2304 or other device content can include configuration settings of the device, media content stored on the device, and/or information associated with a user of the device. Media content stored on the computing system 2300 can include any type of audio, video, and/or image data. The computing system 2300 includes one or more data inputs 2306 via which any type of data, media content, and/or inputs can be received, such as human utterances, user-selectable inputs (explicit or implicit), messages, music, television media content, recorded video content, and any other type of audio, video, and/or image data received from any content and/or data source.

The computing system 2300 also includes communication interfaces 2308, which can be implemented as any one or more of a serial and/or parallel interface, a wireless interface, any type of network interface, a modem, and as any other type of communication interface. The communication interfaces 2308 provide a connection and/or communication links between the computing system 2300 and a communication network by which other electronic, computing, and communication devices communicate data with the computing system 2300.

The computing system 2300 includes one or more processors 2310 (e.g., any of microprocessors, digital signal processors, controllers, and the like), which process various computer-executable instructions to control the operation of the computing system 2300. Alternatively or in addition, the computing system 2300 can be implemented with any one or combination of hardware, firmware, or fixed logic circuitry that is implemented in connection with processing and control circuits which are generally identified at 2312. The computing system 2300 includes active-noise-cancellation circuitry 112, which can be implemented as part of the hearable 102 or the communication device 2302. Although not shown, the computing system 2300 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 2300 also includes a computer-readable medium 2314, such as one or more memory devices that enable persistent and/or non-transitory data storage (e.g., in contrast to mere signal transmission), examples of which include random access memory (RAM), non-volatile memory (e.g., any one or more of a read-only memory (ROM), flash memory, EPROM, EEPROM, etc.), register files, and a disk storage device. The disk storage device may be implemented as any type of magnetic or optical storage device, such as a hard disk drive, a recordable and/or rewriteable compact disc (CD), any type of a digital versatile disc (DVD), and the like. The computing system 2300 can also include a mass storage medium device (storage medium) 2316.

The computer-readable medium 2314 provides data storage mechanisms to store the device data 2304, as well as various device applications 2318 and any other types of information and/or data related to operational aspects of the computing system 2300. For example, an operating system 2320 can be maintained as a computer application with the computer-readable medium 2314 and executed on the processors 2310. The device applications 2318 may include a device manager, such as any form of a control application, software application, signal-processing and control module, code that is native to a particular device, a hardware abstraction layer for a particular device, and so on.

The device applications 2318 also include any system components, engines, or managers to support providing audio content to the user 106. In this example, the device applications 2318 include the audio-based application 206 of FIG. 2. Although described with respect to a hearable 102 and active noise cancellation 114, the techniques for performing multi-rate processing, multi-domain processing, and/or bit-based finite-impulse-response filtering can be adapted for other types of devices and/or use cases.

### Conclusion

Although techniques using, and apparatuses including, multi-rate processing for active noise cancellation have been described in language specific to features and/or methods, it is to be understood that the subject of the appended claims is not necessarily limited to the specific features or methods described. Rather, the specific features and methods are disclosed as example implementations of multi-rate processing for active noise cancellation.

Some Examples are described below.

### Example 1

A method comprising:
generating, using active-noise-cancellation circuitry, multiple anti-noise signal components by processing an input noise reference signal using multiple processing paths of the active-noise-cancellation circuitry, the multiple processing paths associated with different processing rates; and
generating, using the active-noise-cancellation circuitry, an anti-noise signal for active noise cancellation by combining the multiple anti-noise signal components from the multiple processing paths.

### Example 2

The method of example 1, wherein the generating of the multiple anti-noise signal components comprises:
generating a first anti-noise signal component using a first processing path of the multiple processing paths, the first processing path associated with a first processing rate of the different processing rates; and
generating a second anti-noise signal component using a second processing path of the multiple processing paths, the second processing path associated with a second processing rate of the different processing rates, the second processing rate being slower than the first processing rate.

### Example 3

The method of example 2, wherein:
the input noise reference signal has a base sampling rate; and
the first processing rate is approximately equal to the base sampling rate.

### Example 4

The method of example 2, wherein:
the input noise reference signal has a base sampling rate;
the first processing rate is greater than or equal to approximately 50% of the base sampling rate; and
the second processing rate is less than approximately 50% of the base sampling rate.

### Example 5

The method of any one of examples 2 to 4, wherein:
the generating of the first anti-noise signal component comprises filtering the input noise reference signal using a first tunable filter of the first processing path; and
the generating of the second anti-noise signal component comprises:
   downsampling the input noise reference signal using a decimator of the second processing path;
   filtering the decimated noise signal using a second tunable filter of the second processing path; and
   upsampling the filtered decimated noise signal using an interpolator of the second processing path.

### Example 6

The method of example 5, wherein the generating of the second anti-noise signal component further comprises delaying a phase of the decimated noise signal using a phase-correction circuit of the second processing path.

### Example 7

The method of example 5 or 6, wherein:
the filtering of the input noise reference signal using the first tunable filter comprises filtering the input noise reference signal using a first finite-impulse-response filter or infinite-impulse-response filter; and
the filtering of the decimated noise signal using the second tunable filter comprises filtering the decimated noise signal using a second finite-impulse-response filter or infinite-impulse-response filter.

### Example 8

The method of any one of examples 5 to 7, wherein:
the generating the first anti-noise signal component comprises filtering the noise signal on an individual bit value basis; and
the generating of the second anti-noise signal component comprises filtering the decimated noise signal on a multi-bit value basis.

### Example 9

The method of any one of examples 2 to 8, wherein:
the generating of the multiple anti-noise signal components further comprises generating a third anti-noise signal component using a third processing path of the multiple processing paths, the third processing path associated with a third processing rate of the different processing rates; and
the third processing rate is:
   less than the first processing rate and greater than the second processing rate; or
   less than the second processing rate.

### Example 10

The method of any previous example, further comprising:
prior to generating the multiple anti-noise signal components, performing a calibration process to determine parameters of the active-noise-cancellation circuitry, the performing of the calibration process comprising performing an iterative impulse-based approach that fits an impulse response associated with each processing path of the multiple processing paths to at least a portion of a target impulse response.

### Example 11

The method of example 10, wherein the performing of the iterative impulse-based approach comprises:
generating a first fitted impulse response of multiple fitted impulse responses by fitting, for a first processing path of the multiple processing paths, an impulse response of the first processing path to at least a first portion of the target impulse response;
generating at least one other fitted impulse response of the multiple fitted impulse responses by fitting, for each remaining processing path of the multiple processing paths, an impulse response of a selected processing path to at least a second portion of a difference between the target impulse response and one or more previously-generated fitted impulse responses; and
determining the parameters of the multiple processing paths based on the multiple fitted impulse responses.

### Example 12

The method of example 11, wherein the performing of the iterative impulse-based approach further comprises:
prior to determining the parameters, regenerating at least the first fitted impulse response by fitting the impulse response of the first processing path to at least a first portion of the difference between the target impulse response and the at least one other fitted impulse response.

### Example 13

The method of example 12, wherein:
the first portion of the target impulse response represents a beginning time interval of the target impulse response;
the first portion of the difference between the target impulse response and the at least one other fitted impulse response represents the beginning time interval; and
the second portion of the difference between the target impulse response and the first fitted impulse response represents at least an ending time interval.

### Example 14

The method of example 13, wherein the second portion of the difference between the target impulse response and the first fitted impulse response represents the beginning time interval and the ending time interval.

### Example 15

The method of any one of examples 11 to 14, wherein:
the multiple processing paths comprise the first processing path and at least two other processing paths;
the at least one other fitted impulse response comprises at least two other fitted impulse responses respectively associated with the at least two other processing paths;
the first processing path is associated with a fastest processing rate of the different processing rates; and
the generating of the at least one other fitted impulse response comprises generating the at least two other fitted impulse responses based on an order in which the processing rates of the selected processing paths decrease.

### Example 16

The method of any one of examples 11 to 15, wherein the generating of the first fitted impulse response comprises tapering the target impulse response at a transition region between the first portion and the second portion of the target impulse response.

### Example 17

The method of any one of examples 11 to 16, wherein:
the multiple processing paths comprise the first processing path, the second processing path, and a third processing path;
the multiple fitted impulse responses comprise the first fitted impulse response, a second fitted impulse response, and a third fitted impulse response; and
the generating of the at least one other fitted impulse response comprises generating a third fitted impulse response by fitting an impulse response of the third processing path to at least the second portion of the difference between the target impulse response and the first fitted impulse response.

### Example 18

The method of any one of examples 10 to 17, wherein the parameters comprise at least one of the following:
filter coefficients of the multiple processing paths; and
a delay associated with a phase-correction circuit of at least one of the multiple processing paths.

### Example 19

An apparatus comprising:
active-noise-cancellation circuitry configured to perform any one of the methods of examples 1 to 18.

### Example 20

A computer-readable storage medium comprising instructions that, responsive to execution by a processor, cause active-noise-cancellation circuitry to perform any one of the methods of examples 1 to 18.

### Example 21

A method comprising:
generating, using active-noise-cancellation circuitry, at least one first anti-noise signal component by processing an input noise reference signal in accordance with a pulse-density-modulation domain and using at least one first processing rate;
generating, using the active-noise-cancellation circuitry, at least one second anti-noise signal component by processing the input noise reference signal in accordance with a pulse-code-modulation domain and using at least one second processing rate, the at least one second processing rate being slower than the at least one first processing rate; and
generating, using the active-noise-cancellation circuitry, an anti-noise signal for active noise cancellation by combining the at least one first anti-noise signal component and the at least one second anti-noise signal component.

### Example 22

The method of example 21, wherein:
the processing of the input noise reference signal in accordance with the pulse-density modulation domain comprises filtering the input noise reference signal on an individual bit value basis; and
the processing of the input noise reference signal in accordance with the pulse-cod-modulation domain comprises filtering the input noise reference signal on a multi-bit value basis.

### Example 23

The method of example 21 or 22, wherein:
the generating of the at least one first anti-noise signal component comprises filtering the input noise reference signal using a first tunable filter of a first processing path associated with the pulse-density-modulation domain; and
the generating of the at least one second anti-noise signal component comprises:
   downsampling the input noise reference signal using a decimator of a second processing path associated with the pulse-code-modulation domain;
   filtering the decimated noise signal using a second tunable filter of the second processing path; and
   upsampling the filtered decimated noise signal using an interpolator of the second processing path.

### Example 24

The method of any one of examples 21 to 23, wherein the generating of the at least one first anti-noise signal comprises:
processing first samples of the input noise reference signal using a first finite-impulse-response filter comprising a single-tap delay line; and
processing second samples of the input noise reference signal using a second finite-impulse-response filter comprising a multi-tap delay line.

### Example 25

The method of example 24, wherein the first samples of the input noise reference signal represent a higher density of samples compared to the second samples of the input noise reference signal.

### Example 26

The method of example 24 or 25, further comprising:
providing, via an intermediate node within the single-tap delay line, the second samples of the input noise reference signal to the second finite-impulse-response filter.

### Example 27

The method of any one of examples 24 to 26, wherein:
the processing of the first samples comprises generating a first signal;
the processing of the second samples comprises generating a second signal; and
the generating of the anti-noise signal comprises combining the first signal, the second signal, and the at least one second anti-noise signal component.

### Example 28

The method of example 27, wherein:
the generating of the first signal further comprises passing the first signal through a first low-pass filter; and/or
the generating of the second signal further comprises passing the second signal through a second low-pass filter.

### Example 29

The method of any one of examples 21 to 28, further comprising:
generating, using the active-noise-cancellation circuitry, at least one third anti-noise signal component by processing the input noise reference signal in accordance with the pulse-density-modulation domain or the pulse-code-modulation domain and by using a third processing rate, the third processing rate being between the at least one first processing rate and the at least one second processing rate,
wherein the generating of the anti-noise signal comprises generating the anti-noise signal for active noise cancellation by combining the at least one first anti-noise signal component, the at least one second anti-noise signal component, and the at least one third anti-noise signal component.

### Example 30

The method of any one of examples 21 to 29, wherein:
the generating of the at least one first anti-noise signal component comprises filtering the input noise reference signal using a finite-impulse-response filter; and
the generating of the at least one second anti-noise signal component comprises filtering the input noise reference signal using another finite-impulse-response filter or an infinite-impulse-response filter.

### Example 31

The method of any one of examples 21 to 30, further comprising:
delaying the at least one second anti-noise signal component; and
selectively passing a delayed version of the at least one second anti-noise signal component or the at least one second anti-noise signal component to a combiner of the active-noise-cancellation circuitry,
wherein the generating of the anti-noise signal comprises combining the selected signal and the at least one first anti-noise signal component using the combiner.

### Example 32

The method of any one of examples 21 to 31, further comprising:
detecting a presence of an ultrasound signal within the input noise reference signal;
determining a frequency associated with the ultrasound signal;
generating filter coefficients to attenuate the frequency associated with the ultrasound signal; and
filtering, based on the filter coefficients, the frequency associated with the ultrasound signal from within the anti-noise signal.

### Example 33

The method of example 32, wherein the filtering of the frequency comprises filtering the anti-noise signal using an infinite-impulse-response filter having a notch at the frequency of the ultrasound signal.

### Example 34

The method of any one of examples 21 to 33, wherein:
the input noise reference signal has a base sampling rate; and
the first processing rate is approximately equal to the base sampling rate.

### Example 35

The method of example 34, wherein:
the input noise reference signal has a base sampling rate;
the first processing rate is greater than or equal to approximately 50% of the base sampling rate; and
the second processing rate is less than approximately 50% of the base sampling rate.

### Example 36

An apparatus comprising:
active-noise-cancellation circuitry configured to perform any one of the methods of examples 21 to 35.

### Example 37

A computer-readable storage medium comprising instructions that, responsive to execution by a processor, cause active-noise-cancellation circuitry to perform any one of the methods of examples 21 to 35.

### Example 38

A multi-stage, multi-rate interpolator to upsample the processed pulse code noise suppression signal, that includes multiple delay elements so as to adjust fractional delays so that the second impulse response is aligned optimally in time with the first impulse response to perform any of the methods of examples 1 to 18.

1. A method comprising:
generating, using active-noise-cancellation circuitry, at least three anti-noise signal components by processing an input noise reference signal using at least three processing paths of the active-noise-cancellation circuitry, the at least three processing paths associated with at least three different processing rates; and
generating, using the active-noise-cancellation circuitry, an anti-noise signal for active noise cancellation by combining the at least three anti-noise signal components from the at least three processing paths.

2. The method of claim 1, wherein the generating of the at least three anti-noise signal components comprises:
generating a first anti-noise signal component using a first processing path of the at least three processing paths, the first processing path associated with a first processing rate of the at least three different processing rates;
generating a second anti-noise signal component using a second processing path of the at least three processing paths, the second processing path associated with a second processing rate of the at least three different processing rates, the second processing rate being slower than the first processing rate; and
generating a third anti-noise signal component using a third processing path of the at least three processing paths, the third processing path associated with a third processing rate of the at least three different processing rates, the third processing rate being slower than the first processing rate.

3. The method of claim 2, wherein:
the input noise reference signal has a base sampling rate; and
the first processing rate is approximately equal to the base sampling rate.

4. The method of claim 2, wherein:
the input noise reference signal has a base sampling rate;
the first processing rate is greater than or equal to approximately 50% of the base sampling rate; and
the second processing rate is less than approximately 50% of the base sampling rate.

5. The method of claim 2, wherein:
the generating of the first anti-noise signal component comprises filtering the input noise reference signal using a first tunable filter of the first processing path; and
the generating of the second anti-noise signal component comprises:
downsampling the input noise reference signal using a decimator of the second processing path;
filtering the decimated input noise reference signal using a second tunable filter of the second processing path; and
upsampling the filtered decimated input noise reference signal using an interpolator of the second processing path.

6. The method of claim 5, wherein the generating of the second anti-noise signal component further comprises delaying a phase of the decimated input noise reference signal using a phase-correction circuit of the second processing path.

7. The method of claim 5, wherein:
the filtering of the input noise reference signal using the first tunable filter comprises filtering the input noise reference signal using a first finite-impulse-response filter or a first infinite-impulse-response filter; and
the filtering of the decimated input noise reference signal using the second tunable filter comprises filtering the decimated noise signal using a second finite-impulse-response filter or a second infinite-impulse-response filter.

8. The method of claim 5, wherein:
the generating the first anti-noise signal component comprises filtering the input noise reference signal on an individual bit value basis; and
the generating of the second anti-noise signal component comprises filtering the decimated input noise reference signal on a multi-bit value basis.

9. (canceled)

10. The method of claim 1, further comprising:
prior to generating the at least three anti-noise signal components, performing a calibration process to determine parameters of the active-noise-cancellation circuitry, the performing of the calibration process comprising performing an iterative impulse-based approach that fits an impulse response associated with each processing path of the at least three processing paths to at least a portion of a target impulse response.

11. The method of claim 10, wherein the performing of the iterative impulse-based approach comprises:
generating a first fitted impulse response of multiple fitted impulse responses by fitting, for a first processing path of the at least three processing paths, an impulse response of the first processing path to at least a first portion of the target impulse response;
generating at least one other fitted impulse response of the multiple fitted impulse responses by fitting, for each remaining processing path of the at least three processing paths, an impulse response of a selected processing path to at least a second portion of a difference between the target impulse response and one or more previously-generated fitted impulse responses; and
determining the parameters of the at least three processing paths based on the multiple fitted impulse responses.

12. The method of claim 11, wherein the performing of the iterative impulse-based approach further comprises:
prior to determining the parameters, regenerating at least the first fitted impulse response by fitting the impulse response of the first processing path to at least a first portion of the difference between the target impulse response and the at least one other fitted impulse response.

13. The method of claim 12, wherein:
the first portion of the target impulse response represents a beginning time interval of the target impulse response;
the first portion of the difference between the target impulse response and the at least one other fitted impulse response represents the beginning time interval; and
the second portion of the difference between the target impulse response and the first fitted impulse response represents at least an ending time interval.

14. The method of claim 13, wherein the second portion of the difference between the target impulse response and the first fitted impulse response represents the beginning time interval and the ending time interval.

15. The method of claim 11, wherein:
the at least three processing paths comprise the first processing path and at least two other processing paths;
the at least one other fitted impulse response comprises at least two other fitted impulse responses respectively associated with the at least two other processing paths;
the first processing path is associated with a fastest processing rate of the different processing rates; and
the generating of the at least one other fitted impulse response comprises generating the at least two other fitted impulse responses based on an order in which the processing rates of the selected processing paths decrease.

16. The method of claim 11, wherein the generating of the first fitted impulse response comprises tapering the target impulse response at a transition region between the first portion and the second portion of the target impulse response.

17. The method of claim 11, wherein:
the at least three processing paths comprise the first processing path, a second processing path, and a third processing path;
the multiple fitted impulse responses comprise the first fitted impulse response, a second fitted impulse response, and a third fitted impulse response; and
the generating of the at least one other fitted impulse response comprises generating a third fitted impulse response by fitting an impulse response of the third processing path to at least the second portion of the difference between the target impulse response and the first fitted impulse response.

18. The method of claim 10, wherein the parameters comprise at least one of the following:
filter coefficients of the at least three processing paths; and
a delay associated with a phase-correction circuit of at least one of the at least three processing paths.

19. An apparatus comprising:
active-noise-cancellation circuitry comprising:
at least three processing paths configured to generate at least three anti-noise signal components by processing an input noise reference signal using at least three different processing rates; and
a combiner configured to generate an anti-noise signal for active noise cancellation by combining the at least three anti-noise signals components from the at least three processing paths.

20. A computer-readable storage medium comprising instructions that, responsive to execution by a processor, cause active-noise-cancellation circuitry to:
generate at least three anti-noise signal components by processing an input noise reference signal using at least three processing paths of the active-noise-cancellation circuitry, the at least three processing paths associated with at least three different processing rates; and
generate an anti-noise signal for active noise cancellation by combining the at least three anti-noise signal components from the at least three processing paths.

21. The apparatus of claim 19, wherein:
the at least three processing paths comprise a first processing path, a second processing path, and a third processing path;
the at least three different processing rates comprise:
a first processing rate associated with the first processing path;
a second processing rate that is slower than the first processing rate and is associated with the second processing path; and
a third processing rate that is slower than the second processing rate and is associated with the third processing path;
the first processing path comprises a first tunable filter configured to generate a first anti-noise signal component of the at least three anti-noise signal components by filtering the input noise reference signal;
the second processing path comprises:
at least one first decimator configured to generate a first decimated noise signal by downsampling the input noise reference signal;
a second tunable filter configured to filter the first decimated noise signal; and
at least one first interpolator configured to generate a second anti-noise signal component of the at least three anti-noise signal components by upsampling the filtered first decimated noise signal; and
the third processing path comprises:
at least one second decimator configured to generate a second decimated noise signal by downsampling the first decimated noise signal;
a third tunable filter configured to filter the second decimated noise signal; and
at least one second interpolator configured to generate a third anti-noise signal component of the at least three anti-noise signal components by upsampling the filtered second decimated noise signal.
